(19) United States
(12) Patent Application Publication
(10) Pub. No.: US 2023/0267386 A1
(43) Pub. Date: Aug. 24, 2023

(54) METHOD OF OPERATING A CONTAINER CARRIER TERMINAL

(71) Applicant: Portchain ApS, København K (DK)

(72) Inventors: Michael Lindahl, København K (DK); Anders Olivarius, Frederiksberg C (DK); Thor Thorup, Vedbæk (DK); Niels Adam Hedeager Kristiansen, København K (DK)

(73) Assignee: Portchain ApS, København K (DK)

(21) Appl. No.: 18/005,110

(22) PCT Filed: Jul. 9, 2021
(86) PCT No.: PCT/DK2021/050235

§ 371 Date: Jan. 11, 2023

(30) Foreign Application Priority Data
Jul. 13, 2020 (DK) PA 2020 70484

(51) Int. Cl. G06Q 10/04; G06Q 10/083

(52) U.S. Cl. CPC G06Q 10/04; G06Q 10/083

(57) ABSTRACT

The invention relates to a method of operating a container carrier terminal. A container carrier terminal system comprising a model of the container carrier terminal executed on data processing equipment is provided. The model comprises representations of terminal resources and terminal constraints relating to terminal resources such as quay cranes and the representations of terminal resources include representations of the quay cranes. A plurality of container carrier entries are inputted in the terminal system, each container carrier entry relating to a container carrier and associated with a preliminary terminal resource demand including a tentative arrival time. The tentative arrival time is indicative of arrival of the container carrier to the container carrier terminal. A respective subset of the terminal resources are allocated to each container carrier entry to obtain a preliminary terminal resource plan of allocated terminal resources, including automatically validating the allocated terminal resources of the container carrier entries, such as a subset of the quay cranes. The validating includes automatically establishing whether the allocated terminal resources of the container carrier entries comply with the preliminary terminal resource demand associated with the container carrier entries and the terminal constraints. An updated terminal resource demand relating to at least one of the container carrier entries is provided and an updated terminal resource plan is processed on the basis thereof by means of the computer implemented container carrier terminal system.

### FIELD OF THE INVENTION

The present invention relates to a container carrier terminal system and operation of a container carrier terminal.

### BACKGROUND OF THE INVENTION

The invention is dealing with the complex technical task of operating a container carrier terminal. Such terminals are well-known and spread around the world located at relevant locations so as to facilitate and obtain an advantageous container-carried distribution of goods around the world. Over the last many years container carriers have increased in size and the complete container carrier logistic system has developed in size, capacity and complexity. A result of this development is that the available container terminals need to be operated in a way that allows container carriers to arrive and depart from the terminals in a manner where conflicting port calls are kept at a minimum. Different management tools have been provided to facilitate this. Such tools include both long term and short-term execution tools. A challenge related to such known tools is that such tools lack the technical ability to assist the planning and execution in an efficient way.

### SUMMARY OF THE INVENTION

The invention relates to a method of operating a container carrier terminal, comprising the steps of:

providing a container carrier terminal system comprising a model of said container carrier terminal executed on data processing equipment, said model comprising representations of terminal resources and terminal constraints relating to said terminal resources, wherein said terminal resources comprise a plurality of quay cranes and said representations of terminal resources including representations of said plurality of quay cranes;

inputting, in said container carrier terminal system a plurality of container carrier entries, each container carrier entry relating to a container carrier and associated with a preliminary terminal resource demand including a tentative arrival time, wherein said tentative arrival time is indicative of arrival of said container carrier to said container carrier terminal;

allocating a respective subset of said terminal resources to each container carrier entry of said plurality of container carrier entries to obtain a preliminary terminal resource plan of allocated terminal resources, wherein said step of allocating terminal resources comprises automatically validating said allocated terminal resources of the container carrier entries

the allocated terminal resources including a subset of said plurality of quay cranes,

wherein the validating includes automatically establishing whether the allocated terminal resources of the container carrier entries comply with said terminal constraints and said preliminary terminal resource demand associated with said plurality of container carrier entries;

providing an updated terminal resource demand relating to at least one of said plurality of container carrier entries; and

processing an updated terminal resource plan on the basis of said updated terminal resource demand by means of said computer implemented container carrier terminal system.

Creating a terminal resource plan, e.g. a berth plan, is a very complex task since there are multiple resources that need to be deployed, e.g. quays, quay cranes and gangs among several container carriers in order to meet the demands of container carriers. Even for a single container carrier berthing at a quay of a container carrier terminal and being serviced by two quay cranes there are thousands of possible ways of deploying the resources to the container carrier; the two quay cranes may begin loading/unloading of shipping containers at different times, they may operate at different productivity rates (e.g. gross moves per hour), and they may be allocated to the container carrier for different time durations. For a typical container carrier terminal comprising more than two quay cranes and berthing positions for multiple container carriers, the complexity of the planning increases significantly and the number of ways of allocating resources among the container carriers increases so much that not even the most skilled planner would, in practice, be able to identify which way of allocating resources is the most optimal, i.e. which plan has the highest utilization rate of the terminal resources. This complexity of planning typically results in an inefficient allocation of resources short term, but also a short planning horizon since the complexity of planning increases dramatically when planning horizon increases, also causing that most planning is operational and short-sighted. Typically, even skilled planners are not able to reach high utilization rates even for short-term planning of a few days, such as one or two days.

The above described method according to the present invention may be advantageous for several reasons. First, by allocating terminal resources based on a preliminary terminal resource demand, a preliminary terminal resource plan may be provided, extending far into the future. As the validation or even the distribution of terminal resources is performed automatically, e.g. by the container carrier terminal system, a high utilization rate of terminal resources may be achieved even on a long-term basis. The combination of long-term planning based on preliminary terminal resource demand and the automatic validation of terminal resources may give a berth planner additional tools for proactive planning of the operations of the container carrier terminal. As an example, it may be possible for the berth planner, due to the long planning horizon, to contact a container carrier e.g. two weeks in advance of its tentative arrival time and ask the container carrier to arrive at the container carrier terminal later than planned without this affecting the carrier's departure time. This is possible since the allocation of terminal resources has been performed well in advance of the carrier's tentative arrival time, and since the berth planner may be assured that the preliminary terminal resource plan is an operational plan which may be relied upon. Achieving a high utilization rate is generally advantageous in that the berthing times may be reduced for the container carriers. In practice this means that a container carrier may arrive later to and/or depart earlier from the container carrier terminal due to optimal deployment of resources. The more time a carrier has at its disposal to sail a route from one container carrier terminal to the next container carrier terminal the slower the carrier may sail across sea, and the less ship oil needs to be burned resulting in less emission of greenhouse gases and other pollutants, such as sulfur- and nitrogen containing gases.

The above described method according to the present invention may further be advantageous in that changes to the terminal resource plan made in a short-term time horizon may be made with respect to the already established long-term preliminary terminal resource plan.

A further advantage of the above described method according to the present invention may be that the long-term planning of resources, as described above, gives a berth planner a better indication of the utilization of terminal resources over a long time and this may enable the planner to schedule maintenance, such as maintenance of quay cranes, well in advance and with respect to expected utilization of the terminal resources. This ensures that the maintenance may be scheduled for the most optimal point in time where the effect of the maintenance has the least influence of the operation of the container carrier terminal. Scheduling of maintenance, such as maintenance of a quay crane may be problematic if not done with respect to long-term resource allocation since otherwise the scheduled time of maintenance may fall at a critical time where there is a high demand on crane capacity and the crane may furthermore physically hinder movements of adjacent cranes thus rendering a significant quay length unusable for berthing of container carriers.

It should be noted that a container carrier entry relates to a container carrier and that such container carrier at the final execution of the entry is specified to be a specific carrier with known ID, e.g. a name and known properties, such as length. At the start of inputting the container carrier entry, the carrier may indeed be completely defined in a respective data record, but it may also be represented as a dummy carrier having certain properties, e.g. including intended number of containers to be offloaded, expected length etc. This could e.g. happen during a pro-forma planning one time a year. When the carrier is specifically identified the entry may be updated accordingly.

It should be noted that the inputting, in said container carrier terminal system, typically via an input, of a plurality of container carrier entries may be performed on an entry by entry basis or as groups of entries. The container carrier system may of course, when initially activated, receive a complete set of entries at the given time, but from there the container carrier terminal system may typically be updated e.g. when new entries are input, when entries are to be modified or when terminal resources and the associated constraints are modified, intentionally or non-intentionally and when this change needs to be reflected in the container carrier terminal system.

It should be noted that the step of automatically validating allocated terminal resources with respect to an individual and/or several container carrier entries may be invoked automatically upon occurrence of a relevant triggering event. Such a triggering event in the present context does also include a manual triggering of the automatic validation, e.g. via a user interface related to the terminal resource system.

It should also be noted that the validating of whether allocated terminal resources of the container carrier entries comply with said preliminary terminal resource demand associated with said plurality of container carrier entries and said terminal constraints preferably include an automatic determination of whether the demand as expressed via the entry can be met in the sense the allocated terminal resources of the individual entry can in fact do the job and do it without conflicting with allocated terminal resources of other entries. Examples of which constraints to impose in such a validation will be given below.

It should be noted that the running updating of the terminal resource plan may be advantageous as a technical means for optimizing and smoothing the use of resources during berthing even in spite of the fact that optimization reasonably results in a plan which is more vulnerable to the real-world fact that more than 50% of container carriers are delayed when compared to the originally intended ETA.

It should furthermore be noted that the term “preliminary” in relation to the preliminary terminal resource demand and in relation to the preliminary terminal resource plan are associated with a first-time entry of a container carrier entry, i.e. a port call. The resulting terminal resource plan is preliminary as seen from the point of view of the new entry. As seen from the point of view of all other entries already included in the terminal resource plan, the preliminary terminal resource plan will simply be an updated terminal resource plan.

A basic point to make in the present context is that an entry at a very early stage, namely at the time of input into the container carrier terminal system, should be allocated terminal resources which in principle should be operable even if the time of execution, i.e. the time of the effective port call, is in the far future, e.g. weeks or months before execution.

It should also be noted that the invention may work with existing conventional long-term management systems as long as the preliminary resource demand is validated with respect to allocated resources.

In an embodiment of the invention, the step of processing an updated terminal resource plan on the basis of said updated terminal resource demand by means of said computer implemented container carrier terminal system is performed in compliance with updated demands and terminal resources.

In an embodiment of the invention, the step of providing an updated terminal resource demand relates to said plurality of container carrier entries.

In an embodiment of the invention, said step of allocating terminal resources comprises automatic distribution of terminal resources to at least a subset of said container carrier entries.

In the present disclosure, a “container carrier” is understood as a ship, freighter, or vessel specially designed and equipped for carrying and transporting containerized cargo, e.g. shipping containers or intermodal containers, across water. A container carrier may therefore also be referred to as a container ship. In the context of the present invention, a “container carrier terminal” should be understood as an intermediate destination facility that enables shipping containers to switch methods of transport en route to their final destination. Shipping containers are transported on water by container carriers and shipped to a container carrier terminal for unloading before being transported further by land-based transportation such as by trains and trucks to their final destination. Likewise, the container carrier terminal may facilitate a switch from land-based transportation to container carrier in the transport of shipping containers. The container carrier terminal may comprise one or more quays for berthing of container carriers, one or more quay cranes for loading/unloading of shipping containers, one or more prime movers for transport of shipping containers within the container carrier terminal, a container yard for temporary storage of shipping containers.

In the present disclosure, a “container carrier terminal system” is understood as a computer-implemented system for managing terminal resources relating to berthing of container carriers at a container carrier terminal. By computer-implemented is understood that the container carrier entries and the model comprising terminal resources and terminal constraints are stored in digital form in the same or different locations and computer storage types, and that one or more processors are provided to carry out at least one or more steps of the method according to the present invention, such as the step of automatically validating terminal resources, including quay cranes, to the plurality of container carrier entries. In various embodiments, the container carrier terminal system further comprises a graphical user interface (GUI), hence also computer-implemented, i.e. providing a graphical view to a user by display means, and receiving input from the user by any ordinary or special computer input means. The graphical user interface of the container carrier terminal system may thus be regarded as an interface between the system and a user or operator of the system, e.g. a berth planner. The container carrier terminal system may be implemented and running on a single computer, or have different modules separated to different computers, e.g. one computer running an allocation engine/optimization engine, and another computer running the graphical user interface. The container carrier terminal system may be using distributed processing, for example cloud-based processing. The storage of data may be at separate data servers, e.g. cloud-based, or be local in connection with the processing computers.

The container carrier terminal system may be used, by e.g. container carrier terminal planner, as scheduling assistance tool for berthing of container carriers and operations relating to loading and/or unloading of shipping containers on/off container carriers. The container carrier terminal system may be distributed on one or more computer servers, and the container carrier terminal system may be a cloud-based system.

In the present disclosure, a “model” is understood as a computer-implemented representation of the container carrier terminal. The model may comprise various representations of container carrier terminal resources and container carrier terminal constraints, which in the below is referred to as terminal resources and terminal constraints respectively. By modeling the terminal resources and terminal constraints of the container carrier terminal it may be possible by use of the model to allocate terminal resources to container carriers before the container carriers arrive at the container carrier terminal.

In the present disclosure, “a terminal resource” is understood as a deployable asset, such as quay cranes, of the container carrier terminal which serves in the operation of the container carrier terminal, such as in loading/unloading of shipping containers to/from container carriers berthing at the container carrier terminal. The terminal resources may comprise:
Pilots—By a “pilot” is understood a person who maneuvers ships through dangerous or congested waters, such as harbors or river mouths. The pilot is a navigational expert possessing knowledge of the particular waterway such as its depth, currents, and hazards. The pilot may thus be experienced in maneuvering a container carrier through the waterways surrounding the container carrier terminal and safely berth the ship at a position along a quay of the container carrier terminal. The pilot may also be referred to as a maritime pilot, marine pilot, harbor pilot, port pilot or a ship pilot.
Tugboats—By a “tugpilot” is understood any kind of vessel that maneuvers other vessels by pushing or pulling them either by direct contact or by means of a tow line. Tugboats typically move vessels, such as container carriers in or at a container carrier terminal, that are restricted in their ability to maneuver on their own.
Quay length—By a “quay length” is understood a length of section of a quay of a container carrier terminal or a length of an entire quay of a container carrier terminal. By a quay is understood a structure on the shore-side of a container carrier terminal where container carriers may dock/berth to load and unload shipping containers. A container carrier terminal may comprise one or more quays. A quay length may further be understood as a section of a quay, having a length, and which may be allocated to container carriers. As an example, a container carrier may have a length of 398 meters, and therefore at least a quay length, or quay section, of 398 meters must be allocated in order to berth the container carrier at the container carrier terminal. In practice a quay length of more than 398 meters may be allocated in order to make room for maneuvering of the container carrier during berthing at the terminal, and also an additional safety distance between container carriers may be required.
Bollards—By a “bollard” is understood any kind of structure capable of anchoring a container carrier at a quay. The bollards may be distributed along the quay and may also define specific berthing positions along the quay where container carriers may berth.
Quay cranes—By a “quay crane” is understood as a quayside (or dockside) crane for loading/unloading shipping containers to/from container carriers. The quay crane may therefore also be referred to as a ship-to-shore crane. The quay crane may be configured to move along rail tracks along a quay side of the container carrier terminal such that the quay crane may be positioned at necessary positions relative to the berthing container carrier for the loading/unloading of shipping containers. The quay crane may be operated by a dedicated gang of workers or alternatively be an automatically operated quay crane, e.g. an autonomous quay crane. The quay crane comprises a crane boom for reaching in over a berthing carrier to perform loading/unloading operations of shipping containers. The boom may be hinged to allow passage of large container carriers beneath or it may be fixed to reduce airspace being taken up.
Prime movers—By a “prime mover” is understood any kind of vehicle capable of transporting a shipping container from one place to another at the container carrier terminal. The prime mover may be a terminal truck. As an example, the prime mover may be a manually operated terminal truck or a fully autonomous terminal truck.
Straddle carrier—By a “straddle carrier” is understood a container-carrying vehicle that carries its load underneath by “straddling” it, rather than carrying it on top like a conventional truck. The straddle carrier is able to load and unload containers without the assistance of cranes or forklifts. As an example, the straddle carrier may be a manually operated or be fully autonomous.
Stacking crane—By a “stacking crane” is understood a gantry-like crane arranged to lift shipping containers and place/stack the containers at various positions and heights at the yard. The stacking crane may move around on the yard of the container carrier terminal by moving along rails.
Gangs—By a “gang” is understood a unit of workers which together as a team perform an operation relating to loading/unloading of shipping containers. The gang may be a dedicated quay crane gang specifically trained for operating a quay crane, e.g. a specific quay crane of a container carrier terminal. The gangs may work in shifts of e.g. 8 hours

In the present disclosure, a “terminal constraint” may be understood as an operational constraint of the container carrier terminal. The terminal constraint may thus comprise constraints relating to the deployment of terminal resources; however, the terminal constraints may also relate to physical constraints/restrictions of the container carrier terminal such as the physical layout of the container carrier terminal.

The terminal constraints may comprise:
Quay depth—By “quay depth” is understood the distance between the water level at the quay and the seabed beneath. The quay depth may vary along the length of the quay.
Container carrier terminal entry restrictions—By a “container carrier terminal entry restriction” is understood physical limitations relating to the entry point(s) of the container terminal. As an example, a container carrier berthing at a container carrier terminal may have to sail along very specific sailing routes into the quay due to various hazards in the environment surrounding the terminal or due to depth restrictions. It may be for example that the entry route to the container carrier terminal from sea passes through one or more canals or other width restrictions imposed by the landscape or urban environment surrounding the container carrier terminal, and therefore the entry route may be congested due to the presence of other container carriers. Thus, the container carrier terminal entry restriction may be a time-varying restriction due to congestion of container carriers being dependent on time or even due to tides which over the course of a day may change the availability of the container carrier terminal.
Quay crane maintenance—a quay crane is a vital asset to q container carrier terminal as it performs the key critical operations of the terminal, namely loading, unloading, and/or redistribution of shipping containers. As global container traffic steadily increases the workload of the quay cranes also increases, therefore high utilization rates of quay cranes may be desired. A high utilization rate of a quay cranes puts significant stresses on components of the quay cranes (motors, gears, structural components, etc.), and over time these components may degrade or in the worst case fail to such an extent that operations of the quay crane is no longer possible. Alternatively, a quay crane may have to be upgraded to meet new terminal resource demands imposed by ever increasing in size container carriers. As an example, the quay crane may need to be raised in height to accommodate larger ships, or the boom of the crane may need to be enlarged. In other words, a quay crane will need some kind of maintenance from time to time and such maintenance naturally imposes downtime of the quay crane. Downtime of the quay crane due to maintenance is thus a constraint which have to be complied with in the allocation of terminal resources.
Quay cranes may not cross each other along the quay. Typically, quay cranes are arranged to move on rail-like tracks along the quay, and such a track may service more than one quay crane. In such a situation it is clear that quay cranes cannot pass each other on the same set of tracks.
Quay cranes may only be allocated to container carriers if the reach of the quay crane is sufficient for the container operation required.
Gang availability—when operating a quay crane a gang is typically required. The number of gangs available at any given time may be a bottleneck to the operations of the container carrier terminal. As an example, it may not be possible to allocate all quay cranes of a terminal if there is not enough available gangs. The gang availability may be reflected in gang schedules, such as schedules for dayshifts and nightshifts.

In the present disclosure, a “container carrier entry” is understood as a data package representing a respective container carrier in the container carrier terminal system. The container carrier entry may be a port call. The container carrier entry comprises or links to data relevant to the berthing of the container carrier at the container carrier terminal. Such data may be found in container carrier data records. The data may comprise a tentative arrival time, a tentative departure time, a berthing position along a quay of the container carrier terminal, a cargo capacity to be unloaded from the container carrier at the container carrier terminal, a cargo capacity to be loaded onto the container carrier at the container carrier terminal, and a cargo capacity to be redistributed on the container carrier. A cargo capacity may refer to a number of shipping containers or a number of TEU's (twenty-foot equivalent unit). The data may further comprise details on the locations of the cargo capacity to be unloaded/redistributed and details on the locations where containers to be loaded are to be placed on the container carrier. The container carrier entry may further relate to specifics regarding the container carrier itself, such as the length, width, height and depth/draft of the container carrier. The container carrier entry may further comprise data indicative of previous port calls or future port calls of the container carrier with respect to the berthing of the container carrier at the container carrier terminal. By a port call is understood an intermediate stop at a terminal for a container carrier on its scheduled journey. In this regard, a container carrier entry may also be associated with a port call.

In the present disclosure, a “tentative arrival time” is understood as an arrival time of the container carrier in the container carrier terminal. The tentative arrival time may refer to the arrival time of the container carrier at its final berthing position along a quay of the container carrier terminal or it may refer to the arrival time of the container carrier at an entry to the container carrier terminal from which the container carrier may need to maneuver by its own power, or with the help from one or more tugboats, to its final berthing position. The tentative arrival time may also be referred to as an expected time of arrival (ETA) or a requested arrival time. As an example, a container on its way to the container carrier terminal may request a certain arrival time, which may be agreed to by a berth planner of the container carrier terminal, and this arrival time, which is agreed upon, may be an example of a tentative arrival time.

Similarly, the container carrier entry may comprise a tentative departure time. The tentative departure time is understood as a departure time of the container carrier from the container carrier terminal. The tentative arrival time may also be referred to as an expected time of departure (ETD) or a requested departure time. As an example, a container on its way to the container carrier terminal may request a certain departure time, which may be agreed to by a berth planner of the container carrier terminal, and this departure time, which is agreed upon, may be an example of the tentative departure time.

In the present disclosure, a “preliminary terminal resource demand” is understood as demands of the container carriers which the container carrier terminal must strive towards fulfilling through its allocation of terminal resources. The preliminary terminal resource demand may comprise a certain number of tugboats and/or pilots, the number of shipping containers to be loaded, the number of containers to be unloaded, and the number of containers to be redistributed once the container carrier is berthing at the container carrier terminal. Since a tentative arrival time and departure time of the container carrier is already established prior to its arrival in the terminal, these container-related preliminary resource demands may also be translated into a number of container moves to be performed per unit of time. The preliminary terminal resource demand may also relate to the specifications of the container carrier, i.e. the length, width, height and depth of the container carrier, or a preferred side of berthing, i.e. port side or starboard. As an example, a container carrier having a depth under sea level, i.e. the distance from container carriers keel and the waterline of the container carrier also known as the draft of the container carrier, of 15 meters, the container carrier terminal must be able to provide a section of a quay having a depth surpassing this draft. As suggested by the name, the preliminary terminal resource demand represents a terminal resource demand that may be changed at a later stage. A shipping company operating a container carrier may have a contractual agreement with the container carrier terminal that a certain number of shipping containers are to be loaded/unloaded at the container carrier terminal every time the container carrier is berthing and this may be reflected in the preliminary terminal resource demand. Thus, well in advance of the container carrier berthing at the container carrier terminal there may be an agreement on how many containers to be moved, however, in practice, as the container carrier is on its way from a previous port call to the container carrier terminal for berthing the actual amount of containers to be moved may be known, and this may be a different number from the number in the contractual agreement. Changes between such a present terminal resource demand and a preliminary terminal resource demand may be reflected in an updated terminal resource demand. By an “updated terminal resource demand” is therefore understood the most up-to-date knowledge of the resource demands of a container carrier destined for berth at the container carrier terminal.

In the present disclosure, a “preliminary terminal resource plan” is understood as a plan of allocated terminal resources. The plan is preliminary in the sense that the plan is provided on the basis of a distribution of terminal resources complying with preliminary terminal resource demands. The preliminary terminal resource plan may be regarded as a schedule of the terminal resources. For example, the preliminary terminal resource plan may show what quay cranes have been allocated to what container carriers and for which time periods. Furthermore, the preliminary terminal resource plan may also comprise schedules of other terminal resources, such as which quay positions are allocated to which container carriers, i.e. where the container carriers are scheduled to berth at the quay, as well as schedules of gangs such as gangs working on dayshifts and/or nightshifts. As the name suggests, the preliminary terminal resource plan may be updated in the future when updated terminal resource demands are provided.

In the present disclosure, “allocating” may be understood as the act of designating/appointing/assigning a terminal resource, within the model, to a container carrier entry relating to a container carrier expected to arrive in the container carrier terminal at some point in the future. As an example, a container carrier is expected to arrive at the container carrier terminal for berthing two weeks out in the future, thus a container carrier entry, representing that container carrier, comprising a tentative arrival time two weeks out in the future is present in the container carrier terminal system. The preliminary terminal resource demand associated with this container carrier entry may specify a specific number of shipping containers to be loaded, unloaded, and/or redistributed (i.e. moved from one position on the container carrier to another position on the container carrier), and in order to meet this demand in between the tentative arrival time and the tentative departure time, a certain number of quay cranes may be needed. Thus, well in advance of the tentative arrival time, e.g. two weeks prior, specific quay cranes of the container carrier terminal are allocated, in the computer carrier terminal system, to the container carrier entry in order to meet the terminal resource demand. Since the container carrier terminal typically handles/services more than one container carrier at any given point in time, this allocation of resources is performed with respect not only to the preliminary terminal resource demand of a single container carrier entry but also with respect to preliminary terminal resource demands of other container carriers, as well as with respect to terminal restrictions such as number of quay cranes available and possibly also quay crane gangs available for operation of quay cranes. Thus, in practice a subset of terminal resources is allocated to each container carrier entry, this subset may include some or all available terminal resources.

In the present disclosure, “automatically validating” is understood as a process being carried out in relation to the allocation of terminal resources, for example with each change or group of changes to the updated or preliminary terminal resource plan, or at occurrence of changes in the demands, constraints, or entries, at regular or irregular time intervals, etc. The validation being automatic means that it is computer-implemented and provides a result automatically. The triggering of the automatic validation may be automatic as part of the allocation, for example automatically carried out each time a change occurs, and/or be user-triggerable, e.g. upon a user requesting to validate the current terminal resource plan, or for example triggered by a user interacting with a user interface, e.g. using a user interface to modify demands, constraints, container carrier entries and/or terminal resources.

The automatic validation may for example include establishing whether the allocated resources match the demanded resources, e.g. with respect to a tentative arrival time or loading/unloading amount, for each container carrier entry. The automatic validation may for example, in addition or instead, include establishing whether the allocated resources match the terminal constraints, e.g. with respect to maintenance time slots or crane availability. In case the validation shows mismatch of either demands or constraints with the allocated resources, it may not be possible for the terminal to provide the agreed or expected service to the container carrier, for example unloading an estimated number of containers within an estimated time frame because the allocated number of cranes cannot move that amount of containers in that time frame, or the allocated number of cranes do not exist or are not available on the quay in that time frame.

The automatic allocation and automatic validation may be carried out sequentially, for example performing a validation after the allocation, or performing a new allocation after a validation has indicated challenges with the current plan. The allocation and validation may also be carried out iteratively, in particular when major changes of demands or constraints have been entered and validation of the previous terminal resource plan therefor fails on several accounts. In an embodiment the validation is an integrated part of the allocation so each consideration in the allocation is validated before applied to the plan, or so that all possibilities are validated and the option with best validation result is applied to the plan. In an embodiment, the allocation and validation is carried out regularly to keep the preliminary terminal resource plan up to date. It may be advantageous to allow the allocation step to produce a preliminary terminal resource plan several weeks or months ahead on the basis of what current information and estimation is available, even if the plan will thereby most probably be incomplete and flawed, in order to at least have a direction and preliminary knowledge about future capacity of the terminal, and to have a starting point for fine tuning the plan as better information comes in. In such an embodiment it may further be advantageous to utilize the automatic validation step to determine the quality of the preliminary terminal resource plan in terms of for example feasibility or efficiency, and on the basis of the most current data (demands, constraints, entries) which may be different from the data that the allocation was carried out for.

In an embodiment of the invention a demand may be understood as a request implying requirement of a certain demand for a terminal capacity, e.g. in relation to container moves and berth location, and in this embodiment the validation is automatically performed in relation to the requested capacity and how the terminal resources can actually perform in relation to such requested capacity.

In the present disclosure, an “updated terminal resource plan” is understood as a terminal resource plan reflecting allocations of terminal resources that are based on updated terminal resource demand, for example a changed tentative arrival time or container loading amount for a container carrier. The updated terminal resource plan may advantageously be provided for use in terminal systems and/or by terminal resources.

In an embodiment of the invention, said step of providing an updated terminal resource demand relating to said plurality of container carrier entries is initiated automatically in response to modification of one or more container carrier entries of said plurality of container carrier entries.

By implementing the method such that the terminal resource demand is automatically updated when a container carrier entry is modified, an advantageous method may be achieved as it thereby facilitates up-to-date demands and constraints for the next processing of an updated terminal resource plan.

In an embodiment of the invention, said step of processing an updated terminal resource plan relating to said plurality of container carrier entries is initiated automatically in response to modification of available terminal resources.

The availability of terminal resources may change over time. As an example a quay crane may suddenly fail, or it may need maintenance in the near or distant future. Furthermore, schedules of available gangs, such as quay crane gangs, may change over time due to e.g. organizational changes to the container carrier terminal. Thus an automatic processing of an updated terminal resource plan based on the modified availability of terminal resources is advantageous. An automatic processing of an updated terminal resource plan upon an updated terminal resource demand is likewise advantageous.

In an embodiment of the invention, said updated terminal resource demand is provided based on output from one or more container carriers and/or on output from a control center associated with at least one of said one or more container carriers.

A container carrier may contact the container carrier terminal and, such as by phone to an operator of the container carrier system, or directly with the container carrier system through a communication channel, such as a wireless cellular connection. Through such a contact, the container carrier may alert the container carrier terminal about an arrival time later than the tentative arrival time which the container terminal system has previously used in the allocation of terminal resources. The newly updated tentative arrival time as provided by the container carrier may require that a new allocation of terminal resources are needed not only for the container carrier but also other container carriers which are scheduled for berthing at or around the time of the newly updated tentative arrival time of the container carrier. The output may refer to communication in any form, e.g. digital through any electronic communication form, audible through for example telephone, written through for example telefax or email, etc.

Alternatively, the updated terminal resource demand may be communicated via a control center related to a container carrier. Often control centers control and coordinate routings of container carriers, and may thus coordinate adjustments to schedules of container carriers from a carrier point-of-view. A control center may also be referred to as a coordination center.

In an embodiment of the invention, said updated terminal resource demand comprises an updated tentative arrival time.

In an embodiment of the invention, said updated terminal resource demand comprises an updated tentative departure time.

In an embodiment of the invention, said updated terminal resource demand comprises an updated cargo capacity to be loaded, unloaded, and/or redistributed at said container carrier terminal.

The step of processing an updated terminal plan may advantageously include

applying in said container carrier terminal system at least one new container carrier entry or modifying an existing container carrier entry of the container carrier terminal system,

each container carrier entry relating to a container carrier and associated with respective terminal resource demand including a tentative arrival time, wherein said tentative arrival time is indicative of arrival of said container carrier to said container carrier terminal;

allocating a respective subset of said terminal resources to each container carrier entry of said plurality of container carrier entries to obtain an updated resource plan of allocated terminal resources, wherein said step of allocating terminal resources comprises automatically validating allocated terminal resources of the container carrier entries

the allocated terminal resources including said plurality of quay cranes,

the validating including automatically establishing whether the allocated terminal resources of the container carrier entries comply with said terminal resource demand associated with said plurality of container carrier entries and said terminal constraints, said terminal resource demand including said tentative arrival time.

An updated terminal resource plan may not simply involve a single update of a preliminary terminal resource plan motivated by a provided updated terminal resource demand of a single container carrier entry of the many container carrier entries. As time progresses, more container carriers may report disruptions in their itinerary and/or their terminal resource demand, thus more and more changes to the container carrier entries may be provided in the container carrier system within a given time frame, such as within a resource allocation time window, and since allocation of terminal resources among a plurality of container carrier entries is a highly mutually influential process, i.e. a change in the allocation of terminal resources for a first container carrier entry may impose changes to a second container carrier entry in order to comply with terminal constraints, and vice versa, a fundamental change in the terminal resource plan may be required. Furthermore, available terminal resources may change over time, or the terminal constraints relating to the terminal resources may change over time necessitating an updating of the preliminary terminal resource plan for the plan to be rendered operational. Updating of terminal resource plans may also be a simple matter of a desire to fit in further entries or modify the configuration of the available terminal resources.

In an embodiment of the invention, said step of processing an updated terminal resource plan comprises allocating a respective subset of said terminal resources, including said plurality of quay cranes, to each container carrier entry of said plurality of container carrier entries, wherein said step comprises automatically distributing terminal resources, including said plurality of quay cranes, to said plurality of container carrier entries to comply with said updated terminal resource demand and said terminal constraints.

The updated terminal resource plan may be processed in a similar way as the preliminary terminal resource plan is obtained, however taking into account updated terminal resource demand relating to said plurality of container carrier entries. The updated terminal resource demand may relate to a single container carrier entry or it may relate to a plurality of container carrier entries.

In an embodiment of the invention, said step of processing an updated terminal resource plan comprises allocating terminal resources within said resource allocation time window.

Generally, and advantageously, the processing of an updated terminal resource plan relates to allocation of terminal resources within the same time window as the preliminary terminal resource plan or previous updated terminal resource plan relating to the same container carrier entries. In other words, the allocation of terminal resources can also be considered a re-allocation regarding the same container carrier entries. When referring to a same time window or said resource allocation time window, this may encompass that sometimes an updated container carrier entry involves a shift in tentative arrival time or tentative departure time, thereby requiring an extension of the resource allocation time window and/or processing the container carrier entry in a different resource allocation time window.

In an embodiment of the invention, said method comprises a step of providing further updated terminal resource demand and processing a further updated terminal resource plan on the basis of said updated terminal resource demand by means of said computer implemented container carrier terminal system.

The further updated terminal resource demand and further updated terminal resource plan may also be referred to as re-updated terminal resource demand and re-updated terminal resource plan, respectively. The steps of providing an updated terminal resource demand relating to said plurality of container carrier entries and processing an updated terminal resource plan on the basis of the updated terminal resource demand may be performed any number of times, even within the same resource allocation time window. In other words, for a given set of container carrier entries in the container carrier terminal system, a subset of terminal resources allocated for any of the container carrier entries may change through updates. As an example, a quay crane may be allocated to a first container carrier entry according to a preliminary terminal resource plan or updated terminal resource plan and in a subsequent updated terminal resource plan the same quay crane may instead be allocated to a second container carrier entry which is overlapping in time with the first container carrier entry.

Having the ability to perform multiple updates of a terminal resource plan, and even within the same resource allocation time window, is advantageous in that it may be ensured that there is always an operationally functioning plan of allocated resources available in the container carrier terminal system, and this plan is always up to date with the most recent changes to the terminal resource demand relating to the plurality of container carrier entries.

In an embodiment of the invention, said updated terminal resource plan is a previously updated terminal resource plan and said updated terminal resource demand is a previously updated terminal resource demand and wherein an updated terminal resource plan is processed on the basis of said previously updated terminal resource demand.

In an embodiment of the invention, said updated terminal resource plan is processed on the basis of said preliminary terminal resource plan.

Providing an updated terminal resource plan on the basis of a preliminary terminal resource plan may comprise basing the updated plan on a part of the preliminary plan. As an example, a part of the preliminary terminal plan may be set in stone for the future operations of the container carrier terminal and the remaining part of the preliminary terminal resource plan may, subject to an updated terminal resource demand, have to be updated/modified in the process of processing an updated terminal resource plan. As an example, container carrier entries relating to containers that are currently being serviced e.g. one or more quay cranes, and which therefore have already had terminal resources allocated in relation with the obtainment of the preliminary terminal resource plan may be considered set in stone, i.e. not changed or modified, when an updated terminal resource plan is processed.

In an embodiment of the invention, said container carrier terminal system is associated with a database comprising a plurality of container carrier data records, wherein each of said plurality of container carrier data records comprises data associated with a respective container carrier of said plurality of container carriers.

The container carrier system may be associated with a database stored on a single computer server or distributed on a plurality of computer servers. The database may comprise a plurality of container carrier data records, i.e. data records corresponding to respective container carriers. A container carrier data record may comprise general information/data about the container carrier such as the type of the container carrier, size of the container carrier and a schedule of the container carrier sailing routes. Any contractual agreements between the container carrier and the container carrier terminal may also be reflected in the container carrier data records. Such contractual agreements may comprise an agreed amount of shipping containers to be loaded, unloaded, and/or redistributed at the container carrier terminal, and may further comprise times where the container carrier is initially scheduled for arriving and berthing at the container carrier terminal.

Having a database of container carrier data records associated with the container carrier terminal system is advantageous in that data associated with the container carriers that are berthing at the container carrier terminal (including container carriers that have berthed in the past and container carriers berthing in the future) need only be managed by a single database which may be referenced or linked to when e.g. inputting container carrier entries in the container carrier terminal system. By linking to the relevant data or importing the data from the container carrier data records when inputting container carrier entries in the container carrier terminal system is achieved that the risk of wrongly inputting data concerning a container carrier is minimized, as long as the data is correctly input in the container carrier data records in the first place. A further advantage of such container carrier data records is that future container carrier entries may automatically be generated and inputted into the container carrier terminal system.

In an embodiment of the invention, said container carrier terminal system is associated with a database comprising a plurality of quay crane data records, wherein each of said plurality of quay crane data records comprises data associated with a respective quay crane of said plurality of quay cranes.

The container carrier system may be associated with a database stored on a single computer server or distributed on a plurality of computer servers. The database may comprise a plurality of quay crane data records, i.e. data records corresponding to respective quay cranes of the container carrier terminal. A quay crane data record may comprise information/data about the quay crane such as the reach of the quay crane, i.e. how far out from the quay the crane is able to handle shipping containers, the working range of the crane, i.e. the quay length along the quay over which the quay crane is able to move (not withstanding that other quay cranes may be positioned in the way of the quay crane), as well as a maximum productivity (gross moves per hour) of the quay crane.

In an embodiment of the invention, said container carrier terminal system is associated with a database comprising at least one of maintenance data record, wherein each of said at least one maintenance data record data associated with maintenance of a respective quay crane of said plurality of quay cranes.

In an embodiment of the invention, said quay crane data records comprises information about maintenance of respective quay cranes.

A quay crane data record may comprise information on maintenance of a quay crane, such as time and date of a previous maintenance and time and date of a future scheduled maintenance. The records may further comprise a tracking of the use of the quay crane such that maintenance of the quay crane may automatically be suggested by the system when for example the total number of gross moves by the crane reaches a predetermined number since last maintenance of the crane or when the total operation time of the crane reaches a predetermined operation time since last maintenance of the crane. Storing information about maintenance of quay cranes in quay crane data records is advantageous in that the container carrier terminal system may be able to account for future expected maintenance of a quay crane when allocating terminal resources to container carrier entries in the future. If for example, it is determined that a quay crane has 500 hours of operation left, i.e. 500 hours to lift and move shipping containers before a maintenance is required, then due to the capability of the container carrier terminal system in allocating the quay crane to container carrier entries representative of container carriers arriving for berthing in the container carrier terminal way out in the future, the container carrier terminal system is able to proactively deal with a future maintenance since the system may be able to predict when in the future the remaining 500 hours of operation will lapse. Thus, the container carrier terminal system may be able to already take into account that at some point in the future the quay crane may not be an available terminal resource for allocation to container carrier entries and thus the preliminary terminal resource demand of the container carrier entries, at that point in time in the future, may have to be complied with by fewer quay cranes.

Knowing such information in good time puts an operator of the container carrier terminal system in an advantageous position, since a consequence of such a disruption to the terminal operations may be that one or more container carriers may have to arrive later at the container carrier terminal in order for operations to run smoothly. The operator may thus contact a container carrier, e.g. a captain on the carrier, and ask for the carrier to arrive later at the terminal. The earlier a container carrier knows of such changes the better, since the ship may sail a greater distance at a reduced speed contrary to sailing at a higher speed for the most of the trip and then abruptly reducing the speed as it gets close to the terminal. The fuel consumption of a container carrier is greatly dependent on the speed of the container carrier and it has been found that for speeds above 14 knots the fuel consumption of a container grows exponentially with the speed of the container carrier. Thus, by reducing its speed, even slightly, in good time before arrival at the container carrier terminal later, the container carrier may reduce emissions of greenhouse gases significantly.

In an embodiment of the invention, said container carrier terminal system is associated with a database comprising a plurality of gang data records, wherein each of said plurality of gang data records comprises data associated with a gang of said container carrier terminal.

A gang data record may comprise data relating to planned working shifts of gangs, such as quay crane gangs. Knowing information about planned working shifts for gangs is highly advantageous for the allocation of resources, since the number of available gangs at any point in time may represent a bottleneck for the operations of the container carrier terminal. As an example, the number of available quay crane gangs may dictate how many quay cranes may be allocated at any given time. Therefore, information about what gangs are available at any given time in the future may further improve the terminal resource plans generated/processed by the container carrier terminal system.

According to an embodiment of the invention, the container carrier terminal system is associated with a database, wherein the database may comprise any of a container carrier data records, quay crane data records, and gang data records.

In an embodiment of the invention, said container carrier entries are inputted in a resource allocation environment of said container carrier terminal system.

By a “resource allocation environment” is understood a computer-implemented working environment in which the terminal resources of the model may be allocated to the container carrier entries. The resource allocation environment may advantageously facilitate automatic distribution/allocation of terminal resources to container carrier entries. A resource allocation environment is advantageous in that it facilitates a common place for handling of container carrier entries and allocation of terminal resources to these.

In an embodiment of the invention, said resource allocation environment is represented by a graphical user interface of said container carrier terminal system.

Thereby an advantageous embodiment is provided, as the container carrier terminal system provides a highly user friendly and intuitive procedure for allocating terminal resources to container carrier entries, thereby forming preliminary-, intermediate-, and/or updated terminal resource plans.

The graphical user interface is configured to allow the user/operator of the container carrier terminal system to access and/or modify a plan of allocated terminal resources in the resource allocation environment, by presenting graphical elements, i.e. graphical representations of container carrier entries, allocated resources, and/or conflicts of a resource allocation plan on a screen, and facilitating interaction with the graphical elements, by input from the user/operator e.g. by computer mouse, keyboard, touch gestures, etc.

In an embodiment of the invention, said step of inputting a plurality of container carrier entries comprises automatically inputting one or more of said plurality of container carrier entries in said container carrier terminal system.

The container carrier entries may be automatically inputted/imported in the container carrier terminal system using data from external data sources, such as data managed on servers by shipping companies, data managed on servers managed by other container carrier terminals, or other from other data servers relating to the container carrier terminal. In an alternative embodiment of the invention, at least a subset of said plurality of container carrier entries are inputted manually into said resource allocation environment, e.g. by input through a graphical user interface. As an example, the container carrier terminal system may automatically retrieve data from a shipping company indicative of a future berth at the container carrier terminal. This data may specify that a number of containers are expected to be loaded/unloaded/redistributed at the container carrier terminal in the future, and in some cases the data may even indicate, by reference to a vessel name, a specific container carrier such as “Emma Mæsk”. Automatically inputting container carrier entries in the container carrier terminal system, e.g. in a resource allocation environment, is advantageous in that the container carrier terminal system may frequently be updated about future berths at the container carrier terminal and the system may gain access to the newest available information about future berths, since the data sources relied upon in the automatically inputting of container carrier entries may be the earliest indicators of future berths at the container carrier terminal.

In another embodiment of the invention, each of said plurality of container carrier entries is inputted automatically in the container carrier terminal system.

In an embodiment of the invention, said automatically inputting one or more of said plurality of container carrier entries comprises inputting data from said plurality of container carrier data records.

In an embodiment of the invention, said automatically inputting one or more of said plurality of container carrier entries comprises referencing data from said plurality of container carrier data records.

When inputting container carrier entries in the container carrier terminal system, a reference, e.g. by link, association, pointer, copying, etc, may be made to data relating to a specifics about a container carrier, e.g. type of carrier, size of carrier, etc. Such data may be present in a container carrier data record, and may be either pointed to by a pointer in the container carrier entry or hard copied into the container carrier entry.

In an embodiment of the invention, said container carrier terminal system is associated with a database comprising a plurality of container carrier entry data records, wherein each of said container carrier entry data records comprises data associated with a respective container carrier entry of said plurality of container carrier entries.

In an embodiment of the invention, said representations of terminal resources of said model are representations of terminal resources which are physically present at said container carrier terminal, such as physical quay cranes.

The terminal resources of the model are understood as representations of resources physically present at the container carrier terminal. As an example, the model may comprise 5 quay cranes, and this should be understood in such a way that the model comprises computer representations of 5 quay cranes which are actually physically present at the container carrier terminal which is represented by the model. In this regard, the terminal resources of the model are not capable of performing, by themselves, actions relating to operations of a physically present container carrier terminal, these actions are performed by physically present resources, e.g. quay cranes actually present at a container carrier terminal, but these resources may nonetheless be represented by the model and allocated to container carrier entries.

In an embodiment of the invention, said representations of terminal resources comprises representations of one or more physical quay lengths.

In an embodiment of the invention, said representations of terminal resources comprises representations of one or more physical bollards.

In an embodiment of the invention, said representations of terminal resources comprises representations of one or more physical gangs.

In an embodiment of the invention, said preliminary terminal resource demand comprises a container carrier length.

In an embodiment of the invention, said preliminary terminal resource demand includes a tentative departure time.

A container carrier on its way to the container carrier terminal may request a certain departure time, which may be agreed to by a berth planner of the container carrier terminal, and this departure time, which is agreed upon, may be an example of the tentative departure time. Having a tentative departure time as part of the preliminary resource demand is advantageous for the execution of the method, and in particular for the allocation of terminal resources. By having access to a tentative departure time, the allocation of terminal resources may be better allocated/distributed to the plurality of container carrier entries.

In an embodiment of the invention, said tentative arrival time and/or tentative departure time is automatically retrieved and inputted in said container carrier entry.

In an embodiment of the invention, said tentative arrival time and/or tentative departure time is automatically predicted.

The container carrier terminal system may be arranged to automatically retrieve the tentative arrival/departure time from external sources, such as from data sources managed by the operator of the container carrier, e.g. a shipping company. In an alternative embodiment of the invention, the tentative arrival time is automatically predicted based on e.g. AIS-data (Automatic Identification System data). Automatically retrieving and inputting the tentative arrival time and/or tentative departure time is advantageous in that container carrier entries may thereby easier be automatically inputted in the container carrier terminal system.

In an embodiment of the invention, said preliminary terminal resource demand is based on an estimated terminal resource demand.

In an embodiment of the invention, said estimated terminal resource demand comprises a preliminary quay crane demand.

An estimated terminal resource demand may for example be indicative of a number of containers to be moved, a number of TEU units to be moved, or a number of quay crane workhours required to service a container carrier at the container carrier terminal.

Introducing an estimated terminal resource demand is advantageous, since it allows an approximate allocation of terminal resources, which in turn may ensure proper delivery of goods and reduced emission of greenhouse gases.

In an embodiment of the invention, said estimated terminal resource demand is based on a contractual terminal resource demand.

A contractual terminal resource demand may for example be based on a long-standing contractual agreement, e.g. a so-called pro-forma plan. Here, a contractual number of containers to be transferred by a certain container carrier in a certain container carrier terminal may for example be stated. However, such contractual numbers are often imprecise and/or inaccurate.

Basing an estimated terminal resource demand on a contractual terminal resource demand is advantageous, since the contractual terminal resource demand may to some degree be indicative of an updated terminal resource demand or an actual terminal resource demand.

In an embodiment of the invention, said preliminary terminal resource demand comprises a container-related berth workload.

A container-related berth workload may for example relate to a cargo capacity to be loaded, unloaded, and/or redistributed by the quay cranes of the terminal in relation to a container carrier entry. Alternatively, a container related berth workload for example relate to a number of quay crane workhours. The container-related berth workload may be a single number representing the total amount of work, e.g. by a number of container moves or crane hours, or it may be a multi-dimensional parameter that provides individual numbers for loading, unloading and redistribution, respectively, to allow for more accurate allocation depending on the types of tasks. Regardless of the way of quantifying the workload, one or more cranes may be allocated to match the container-related berth workload. A balance exists between the number of cranes allocated and the time required to carry out the container moves, as generally the more cranes allocated for the workload, the faster the work can be done.

In an embodiment of the invention, said estimated terminal resource demand is based on static carrier information.

Static carrier information may be understood as information relating to the carrier and which is generally static, i.e. the information does not change substantially on time scales relevant for berth planning and crane allocation. Examples of static carrier information is a name or tag which identifies a container carrier, a shipping company related to a container carrier, a size related to a container carrier, and a container volume related to a container carrier. Static carrier information may further relate to information relating to a route of a container carrier, and in that sense static carrier information may also be referred to as static route information. Static carrier information may in other words be considered as such data related to a container carrier or shipping route which are the same for each visit to the container terminal, i.e. each berth of this container carrier or shipping route. This is opposed to non-static data that changes from berth to berth even of the same ship in the same container terminal, such as arrival and departure times, actual number of container moves required this time, etc.

Typically, container carriers sail a predetermined container carrier route which include container carrier berths at several predetermined terminals. A shipping company may then provide many container carriers to sail the route, such that a steady arrival and departure of container carriers may be ensured throughout the route. In some sense, such a route may be considered analogous to a bus route in which several buses visit several bus stops to ensure a steady arrival and departure of busses thought the bus route. In the technical field of container shipping such a route may also be referred to as a service, a service route, and a shipping route.

Contractual agreements between shipping companies and container carrier terminals, e.g. pro-forma plans, may typically concern scheduling of such a container carrier route, e.g. the frequency with which any container carrier of that route may visit a given terminal, a contractual number of containers to be loaded and unloaded etc.

The invention of estimating a terminal resource demand such as an estimated container-related berth workload based on static carrier information, i.e. before knowing the actual cargo capacity that will have to be loaded, unloaded and/or redistributed in relation to a future berth, and performing allocation of terminal resources such as quay crane on the basis of the estimated workload, allows for planning and adjusting the crane-amount/crane-time balance significantly earlier than when waiting for actual workload information, thereby having more freedom to make an efficient allocation because more and more parameters get locked as the berth date approaches.

In an embodiment of the invention, an estimated container-related workload of said estimated terminal resource demand is estimated by a workload predictor executed by data processing equipment.

A workload predictor, also referred to as workload estimator, may advantageously be implemented in a computer system, preferably the container carrier terminal system, to perform the estimation of a container-related workload for a container carrier entry.

The workload predictor may comprise executable implementations of algorithms, mathematical functions, lookup tables, artificial intelligence, etc., arranged to estimate container-related workload from static carrier information.

In an example, the workload predictor may be arranged to calculate an average workload WLa over the past 12 months for workloads WLbn of past berths Bn-1, Bn-2, . . . , Bn-12 of a certain container carrier carrier_id visiting the terminal each month and provide this average as an estimate WLe of the workload for the next berth Bn of this certain container carrier, e.g.:

WLe(carrier_id,n)=WLa(carrier_id)=ΣWLbn-i/12, i=1 . . . 12.

In another example, the workload predictor may comprise a lookup table where historic data have been aggregated and grouped according to container carrier vessel size categories and time of year, and the workload predictor provides an estimate workload for a certain berth by looking up the container carrier vessel class and date in the table and reading the associated workload estimate. The look-up table may for example resemble the following, with the estimated workloads referring to estimated TEU capacity to be unloaded/loaded/redistributed:

| Season\Size | Panamax | Post-Panamax | New Panamax | ULCV |
|---|---|---|---|---|
| Spring | 250 | 425 | 900 | 1,300 |
| Summer | 150 | 200 | 500 | 900 |
| Fall | 300 | 500 | 1,000 | 1,500 |
| Winter | 200 | 350 | 700 | 1,100 |

In another example, the workload predictor may be arranged to perform an exponentially weighted moving average function implemented as an infinite impulse response (IIR) filter configured to average the number of container moves WLm,a required at each berth in a certain terminal by a certain shipping route or other relevant grouping, store this average WLm,a(old) for each group, update the average based on actual container moves WLm at the most recent berth in that group to obtain WLm,a(new), and use the newest average of a relevant group for estimating a number of container moves WLm,e of a scheduled berth, identifying the relevant group from static carrier information related to the scheduled berth, such as the shipping route. For example by the following formula which both updates the average with the most recent actual value and provides the new estimate for the next berth, and where 0<α<1 is a smoothing factor where increasing a increases emphasis on recent values:

WLm,e=WLm,a(new)=α*WLm+(1−α)*WLm,a(old)

In another example, the workload predictor may include a mathematical model of patterns among past workloads, the mathematical model being generated by machine learning applied by the workload predictor or elsewhere arranged to perform pattern recognition or classification among training data encompassing a historic berth database, and is arranged to use the mathematical model to predict a workload for a future berth based on static carrier information including one or more of for example container carrier name, type, time of year, shipping route, shipping company, etc.

In an embodiment of the invention, said estimated terminal resource demand is based on a resource prediction algorithm.

In an embodiment of the invention, said workload predictor is associated with a workload prediction algorithm.

An algorithm, e.g. a computer-implemented algorithm, is well-suited for generating the estimated terminal resource demand or the estimated container-related berth workload. An algorithm can for example rapidly search databases such as a historic search database, process data, search lookup tables such as a berth lookup table, perform calculations, perform automated reasoning, or any combination of these.

A resource or workload prediction algorithm according to the invention may be any type of algorithm which is able to, at least partially, participate in generating an estimated container-related berth workload or resource demand.

Using a resource or workload prediction algorithm is advantageous, since it enables complex calculations and problem solving to be implemented to quickly provide a precise and accurate estimated container-related berth workload or resource demand, which in turn may result in reduced delivery time of goods and reduced emission of greenhouse gases.

In an embodiment of the invention, said static carrier information represent one or more of the following: a container carrier identifier, a container carrier type, a container carrier manager, a container carrier size, and a container carrier volume.

A container carrier identifier may be understood as name or a tag which identifies the container carrier. Examples of container carrier identifiers are container carrier name, optionally including a ship prefix based on the type of ship, a serial code, an alphanumeric ID. A container carrier identifier may be permanent for a container carrier while others may be changes, e.g. by a manager of the container carrier, or by a manager of a terminal.

A container carrier type may for example be related to a class of the container carrier or a size category. Examples of size categories are Small Feeder, Feeder, Feedermax, Panamax, Post-Panamax, New Panamax, and Ultra Large Container Vessel, ULCV. Examples of classes are Maersk Triple E class, COSCO Guangzhou class, Explorer class, and Bay class.

A container carrier manager may for example be a shipping company related to the container carrier. A specific shipping company may, for example, systematically require a small (or large) number of containers to be unloaded, making the container carrier manager a technically relevant parameter for generating an estimated resource demand or estimated container-related berth workload.

A container carrier size may for example be indicative of length, height, width, beam, weight, and/or draft. A carrier container volume may for example be indicative of its maximum capacity of containers. For example, a container volume may be 18,270 TEU.

A static carrier identifier according to the invention may be approximate, e.g. related to an interval. For example, a static carrier identifier may be a container carrier length from 250 meters to 300 meters or a carrier container volume from 10,000 TEU to 14,500 TEU. For example, in an embodiment of the invention, any incoming container carrier is binned into one of several carrier container volume intervals, and an estimated container-related berth workload is generated for each container carrier based on which carrier container volume interval it lies within.

Using a representation of one or more of container carrier identifier, container carrier type, container carrier manager, container carrier size, and carrier container volume as static carrier information is advantageous, since these various parameters are indicative of the number of containers which the container carrier may transport, and thus indicative of how large the actual container-related berth workload is.

In an embodiment of the invention, said estimated resource demand or an estimated container-related workload thereof is based on container carrier route information.

It is not uncommon that several container carriers sail the same route and visit the same container carrier terminals to ensure a regular flow of goods. Such container carriers may be more likely to have similar actual resource demands or container-related berth workloads. Thus, using container carrier route information to generate an estimated resource demand or estimated container-related workload may improve the accuracy of the estimate, which in turn may yield a more precise crane time window, which in turn may ensure delivery of goods, reduce delivery time of goods, and/or reduce emission of greenhouse gases.

Container carrier route information may for example relate to a container carrier route identifier, a geographical route, information relating to other terminals on the route, and/or information relating to other container carriers sailing the same route.

Typically, container carrier route information may be indicative of at least some static carrier information. E.g. a certain container carrier route may be associated with a certain group of container carriers and/or a certain container carrier type. As such, in some embodiments of the invention, static carrier information according to the invention may be supplied and used indirectly for generating an estimated resource demand or an estimated container-related workload, e.g. as part of the carrier route information. Static carrier information may thereby also be understood as container carrier route information, also referred to as static route information.

In an embodiment of the invention, said estimated terminal resource demand or an estimated container-related workload thereof is generated based on a berth lookup table.

A berth lookup table may for example operate in combination with static carrier information and/or container carrier route information. A berth lookup table may for example be based on container carrier identifier, container carrier type, shipping company, container carrier size, and/or container carrier volume.

A berth lookup table may be understood as a lookup table, e.g. an array or table of information indicative of terminal resource demand, for example relating to static carrier information. For example, each container carrier type may have an entry with an associated cargo capacity in the berth lookup table, and upon scheduling of a container carrier berth of a container carrier, the container carrier type of that container carrier may be used in comparison with the berth lookup table to find the entry of that container carrier type and use the associated cargo capacity as basis for the estimated terminal resource demand, e.g. estimated container-related workload.

Basing the estimated terminal resource demand on a berth lookup table is advantageous, since it is easy to implement, update, understand, and access for the user. The berth lookup table may for example be computer implemented.

In an embodiment of the invention, said estimated terminal resource demand is based on user input.

For example, a computer implemented container carrier terminal system may provide an estimated terminal resource demand, which an experienced user may use as basis for providing a more precise user-established estimated container-related berth workload, e.g. based on the experience and/or knowledge of the user, which is advantageous.

In an embodiment of the invention, said estimated terminal resource demand is based on a historic berth database.

In an embodiment of the invention, said historic berth database comprises a plurality of records of past container carrier berths.

A past container carrier berth may be understood as a past port call, and accordingly, a historic berth database may for example comprise information relating to past container carrier berths of specific container carrier terminals, container carriers, container carrier types, shipping companies, container carrier routes etc. A historic berth database may further comprise information relating to time of year and time of day, prominent world or local events, etc. Further, a historic berth database may comprise information relating to past shipping conditions, e.g. information relating to the magnitude of past flow of containers through supply chains, a past number of container carriers, a past number of container carrier terminals etc. However, note that a historic berth database according to the invention is not restricted to any particular information, extent of information, or type of database.

A historic berth database is a great basis for generating an accurate and precise estimated terminal resource demand or estimated container-related workload, which is advantageous.

Further, a historic berth database may provide new insights to container terminal carrier management in general, which may further increase efficiency, resulting in reduced delivery time of goods and reduced emission of greenhouse gases.

In an embodiment of the invention, said resource prediction algorithm or said workload prediction algorithm is based on computational statistics wherein said historic berth database is used as a statistical database for said computational statistics.

In an embodiment of the invention, said resource prediction algorithm is based on machine learning and wherein said historic berth database is a training dataset used for said machine learning.

Machine learning may be understood as improvement of algorithms or computer models through experience. Machine learning typically requires a training dataset, which the algorithm to be trained may use to gain experience. As such, an algorithm can be enhanced to make more accurate predictions/estimates and/or make better decisions. As such, machine learning may be considered related to computational statistics which focuses on making predictions using computers.

Many different types of machine learning algorithms exist, such as supervised learning, unsupervised learning, semi-supervised learning, reinforcement learning, self learning, feature learning, sparse dictionary learning, anomaly detection, robot, learning, association rules etc.

Performing machine learning often involves creating a machine learning model, which is trained on training data, e.g. the historic berth database, and which can then process additional data to make predictions, e.g. an estimated container-related workload. Examples of machine learning models are artificial neural networks, decision trees, support vector machines, regression analysis, Bayesian networks, genetic algorithms etc.

Note that the resource prediction algorithm according to the invention is not restricted to any particular type of machine learning and machine learning model and may be implemented in any manner by a skilled person, within the scope of the claims.

In some embodiments of the invention, the resource prediction algorithm may be considered a type of artificial intelligence.

In some embodiments of the invention, the estimated terminal resource demand may be indirectly based on the database. For example, a container carrier terminal system used for generating an estimated terminal resource demand may be linked to a resource prediction algorithm which provides the estimated terminal resource demand, where the historic berth database has been used as a training dataset for machine learning of the resource prediction algorithm, while the container carrier terminal system cannot access the historic berth database itself.

Basing a resource prediction algorithm on computational statistics or machine learning is advantageous, since these types of methods are able to provide improved predictions/estimates and/or make better decisions, which in this context may correspond to generating a more accurate and precise estimated terminal resource demand, which in turn may result in reduced delivery time of goods and/or reduced emission of greenhouse gases.

In an embodiment of the invention, said preliminary terminal resource demand comprises cargo capacity to be loaded, unloaded, and/or redistributed at said container carrier terminal.

Cargo capacity may be understood as a measure of the amount of containerized cargo. For example, a number of containers or a number of units of TEU, where TEU is twenty-foot equivalent units, which is a unit of cargo capacity often used to describe the capacity of container carriers and container terminals. Sometimes a container carrier gets completely unloaded and/or loaded during a single berth, and thereby the required workload roughly corresponds to the cargo capacity of the container carrier. However, more typically the container carriers unload and load only partially in each terminal they visit and the required workload is thereby not the total cargo capacity of the vessel.

In an embodiment of the invention, said terminal constraints comprises quay depth.

A quay has a certain depth along the length of the quay and this may impose limitations to what container carriers may berth at specific positions along the quay.

In an embodiment of the invention, said terminal constraints comprises quay crane move restrictions.

By quay crane move restrictions is understood restrictions to the movement of one or more quay cranes of the container carrier terminal. For example, two quay cranes may not move into one another and pass each other. Furthermore, a quay crane which is under maintenance may not move along the quay and it may block the available working space for other quay cranes at the same quay.

In an embodiment of the invention, said terminal constraints comprises quay crane maintenance.

In an embodiment of the invention, said terminal constraints comprises weather restrictions.

The quay depth may depend on tides, and furthermore operations of the container carrier terminal may be hampered by bad weather. As an example, the productivity of a quay crane may be affected by visibility.

In an embodiment of the invention, said weather restrictions are based on weather forecasts or historic weather data.

In an embodiment of the invention, said step of allocating a respective subset of said terminal resources to each container carrier entry of said plurality of container carrier entries comprises allocating a respective quay position to each container carrier entry of said plurality of container carrier entries.

By including allocation of quay positions when allocating terminal resources to the container carrier entries may be achieved significant advantages. By doing so, the allocation/designation of quay positions may be performed with respect to other available terminal resources.

In an embodiment of the invention, said step of allocating a respective subset of said terminal resources to each container carrier entry of said plurality of container carrier entries is performed for a resource allocation time window.

In the present disclosure, a “resource allocation time window” is understood as a time interval in which terminal resources may be allocated to container carrier entries. The resource allocation time window spans a time interval from present time and long into the future, such as to allocate resources to container carrier entries associated with container carriers which have not even set off from a preceding port call.

In an embodiment of the invention, said allocating said at least one quay crane is performed from 2 days to 90 days prior to said container carrier berth, such as from 3 days to 60 days, for example from 4 days to 20 days, for example 7 days or 14 days, such as at least 1 week, 2 weeks, 3 weeks, 1 month or 2 months prior to said container carrier berth.

In an embodiment of the invention, said automatically validating and/or at least partly distributing terminal resources is carried out with respect to one or more allocation targets.

In an embodiment of the invention, said one or more allocation targets comprise an allocation target from the list of earlier time of departure ETD, later arrival ETA, reduced between-tasks crane movement, reduced number of resource allocation peaks, reduced magnitude of resource allocation peaks.

Performing the allocation of resources according to an allocation target is advantageous as it enables achieving technical advantages that would otherwise not be possible with a less aimed approach. For example allocation targets relating to allowing container carriers to arrive later or depart earlier, and making this allocation in good time, i.e. several days or weeks before the berth is scheduled to take place, among other advantages makes it possible for the container carriers to slow down and thereby reduce the emission of greenhouse gasses. For example, an allocation target of minimizing the movement or relocation of cranes between task may among other advantages reduce the wear on the cranes. For example reducing amount or level of resource allocation peaks, i.e. times where the terminal is too busy with risks of accidents, additional wear, errors, insufficient flexibility to handle unforeseen events, or too idle causing inefficiency and wasted resources.

In an embodiment of the invention, said step of automatically validating and/or distributing terminal resources, including said plurality of quay cranes, to said plurality of container carrier entries to comply with said preliminary terminal resource demand, involves calculating a theoretical required number of cranes NCt by a formula corresponding to:

NCt=WLe/(Tb*Pc)

wherein WLe is an estimated container-related workload of said preliminary terminal resource demand, Tb is a duration of said container carrier entry, and Pc is a measure of average crane productivity.

From an estimated container-related workload WLe to be handled at a terminal with an average crane productivity Pc during a port call with an expected duration Tb, one of the possible solutions may be calculated by first calculating the theoretically required number of cranes NCt. From this number, several solutions of feasible allocations of cranes may be derived.

In an embodiment of the invention, said step of automatically validating and/or distributing terminal resources, including said plurality of quay cranes, to said plurality of container carrier entries to comply with said preliminary terminal resource demand, involves calculating a theoretical required number of cranes NCt, and rounding said theoretical required number of cranes NCt up to an integer number of cranes NC.

The calculated theoretical number of cranes NCt may be a non-integer. One possible solution for the allocation is then to round NCt up to the nearest higher integer to get an integer number of cranes NC to allocate.

In an embodiment of the invention, said step of automatically validating and/or distributing terminal resources, including said plurality of quay cranes, to said plurality of container carrier entries to comply with said preliminary terminal resource demand, involves calculating a required average length of crane time windows Tc from a number of cranes NC by the formula:

Tc=WLe/(NC*Pc)

wherein WLe is an estimated container-related workload of said preliminary resource demand, NC is said number of cranes, preferably derived from a theoretically required number of cranes NCt, and Pc is a measure of average crane productivity.

Solutions for the allocation can be found by calculating different crane time window lengths if more than one crane is allocated, or reduce the common crane time window for all the allocated cranes. For example, starting from an actual number of cranes NC achieved by rounding a theoretical number NCt up, the required average length of the crane time windows Tc, which will be shorter than the berth duration Tb, may be found.

Other possible allocation solutions involve allocating even more cranes and reduce the lengths of the crane time windows commonly or individually. The formula above can also be used to find the resulting average crane time windows required when increasing the number of cranes NC.

In more advanced embodiments non-productive time such as idle time, crane preparing time, buffer time, inspection time, etc., may be taken into account to result in the number of cranes multiplied by the length of their respective crane time windows and their respective productivity exceeding the estimated workload by an amount corresponding to the various added non-productive time.

In an embodiment of the invention, said preliminary resource demand is indicative of a cargo capacity to be unloaded, loaded and/or redistributed from said container carrier to said container carrier terminal during said container carrier entry.

A cargo capacity may for example be understood as a number of containers or be parameterized by a unit of cargo capacity such as TEU.

Two typical tasks of a quay crane in relation to a container carrier berth is to unload containers from the container carrier to the container carrier terminal, and load containers from the container carrier terminal to the container carrier. Additionally, a quay crane may also redistribute containers on the container carrier, since otherwise some containers may be inaccessible or a weight distribution on the container carrier may be imbalanced. Unloading and loading may typically be performed from/to a quay and/or yard of the container carrier terminal.

From an estimated cargo capacity to be handled at the terminal during a container carrier entry, the allocation step involves determining a suitable combination of number of cranes and length of crane time window which allows for handling the estimated cargo capacity preferably within the expected duration of the scheduled berth. By specification of the general formula above, the estimated cargo capacity WLcc to be handled divided by the expected duration Tb of the container carrier entry and further divided by the average productivity in cargo capacity per crane Pc, cc gives the theoretically required number of cranes NCt:

NCt=WLcc/(Tb*Pc,cc)

For example with cargo capacity of 600 TEU, berth duration of 4 hours and average productivity of 40 TEU/h per crane:

NCt=600/(4*40)=3.75 cranes.

This number could either be rounded up to an allocation of 4 cranes which also provides some buffer time for unforeseen or non-productive events, or be fine-tuned by allocating different crane time windows for each crane, e.g. only allocating 3 hours for one of the cranes, and 4 hours for the other three cranes.

Having the estimated container-related berth workload being indicative of the cargo capacity to be unloaded, loaded, and/or redistributed is advantageous, since these tasks are typical tasks of quay cranes, and estimating these numbers thus allows optimum scheduling of quay cranes, which in turn may reduce delivery time of goods and emission of greenhouse gases.

In an embodiment of the invention, said estimated container-related berth workload is indicative of a number of containers to be moved in relation to said container carrier berth.

A number of containers to be moved, also referred to as container moves or simply moves, may for example be understood as the sum of the number of containers to be unloaded, the number of containers to be loaded, and the number of containers to be redistributed. The parameter may also be given as a separate number for each type of move, i.e. load, unload and redistribution.

From an estimated number of containers to be moved at the terminal during a container carrier entry, the allocation step involves determining a suitable combination of number of cranes and length of crane time window which allows for handling the estimated container moves preferably within the expected duration of the container carrier entry. For example, the estimated container moves WLm to be handled divided by the expected duration Tb of the container carrier entry and further divided by the average productivity given in moves per crane Pc,m, such as the common measure Gross Moves Per Hour, GMPH, gives the theoretically required number of cranes NCt:

NCt=WLm/(Tb*Pc,m)

For example, with estimated workload of 500 container moves, berth duration of 6 hours and average productivity GMPH of 30 moves/h per crane:

NCt=500/(6*30)=2.78 cranes.

This could either be rounded up to an allocation of 3 cranes which also provides some buffer time for unforeseen or non-productive events, or be fine-tuned by allocating different crane time windows for each crane.

For example, by applying the formula Tc=WLe/(NC*Pc) discussed above, the required average crane time window Tc if allocating 4 cranes instead of 3 to the scheduled berth can be calculated:

Tc=500/(4*30)=4.17 hours=4 hours and 10 minutes, i.e. a considerably shorter time than the scheduled berth duration Tb of 6 hours.

Having the estimated resource demand being indicative of the number of containers to be moved is advantageous, since estimating this number allows optimal scheduling of quay cranes, which in turn may reduce delivery time of goods and emission of greenhouse gases.

In an embodiment of the invention, said estimated resource demand is indicative of a number of crane moves to be performed in relation to said container carrier berth

Some quay cranes are able to pick up and move more than one container at a time. A quay crane may for example move two containers at a time, or four containers at a time. The number of crane moves may thus be lower than the number of containers to be moved, since one crane move may move more than one container.

Having the estimated resource demand being indicative of the number of crane moves to be performed is advantageous, since estimating this number allows better scheduling of quay cranes, which in turn may reduce delivery time of goods and emission of greenhouse gases.

Note that during a container carrier entry, a quay crane may alternate between loading and unloading containers to maximize utilization of the crane moves. In some embodiments of the invention, such optimized crane moves may be taken into account in the estimated container-related berth workload, whereas in other embodiments it may not.

In an embodiment of the invention, said estimated resource demand is indicative of a number of quay crane workhours required during said container carrier entry.

A number of quay crane workhours is not restricted to natural numbers of mathematics but may be any type of number, e.g. a number including decimals and/or a fraction. Some examples of quay crane workhours are 2.5 hours, 3 hours and 43 minutes, and 7/3 hours. From a number of estimated required quay crane workhours, the allocation step may involve determining a suitable combination of number of cranes and length of crane time window which provides for the estimated quay crane workhours. For example, the estimated crane workhours WLwh required divided by the expected duration Tb of the container carrier entry gives the theoretically required number of cranes NCt:

NCt=WLwh/Tb

This value can be rounded up to an integer to arrive at a possible allocation solution, and other solutions be calculated by adjusting the crane time windows for individual cranes, or use a higher number of cranes.

Having the estimated resource demand being indicative of a number of crane workhours is advantageous, since estimating a number of workhours allows improved scheduling of quay cranes, which in turn may reduce delivery time of goods and emission of greenhouse gases.

In an embodiment of the invention, said estimated resource demand is indicative of a container location distribution onboard said container carrier.

The container location distribution onboard a container carrier may in some cases be important for quay crane operations during a container carrier entry. It may for example determine whether it is necessary to move containers to access containers to be unloaded, whether multiple containers can be picked up at a time be a quay crane, and/or how many quay cranes can access containers to be unloaded at a time.

Having the estimated resource demand being indicative of a container location distribution is advantageous, since estimating container location distribution allows enhanced scheduling of quay cranes, which in turn may reduce delivery time of goods and emission of greenhouse gases.

In an embodiment of the invention, said estimated resource demand is indicative of a container weight and/or a number of empty containers.

Empty containers and heavy containers may typically require to be handled differently than regular containers during container carrier entry. They may for example require to be moved or stored differently.

As such, estimating information relating to container weight and number of empty containers is advantageous, since it enables a more detailed quay crane allocation.

In an embodiment of the invention, said automatically validating and/or distributing terminal resources is performed on the basis of an optimization routine.

The optimization routine may be used in any of the steps of obtaining a preliminary resource allocation plan, processing an updated resource allocation plan, and processing one or more intermediate resource allocation plans.

In an embodiment of the invention, said optimization routine is arranged to distribute terminal resources to comply with said terminal constraints and said preliminary terminal resource demand and to optimize distribution of terminal resources with respect to one or more optimization targets.

In an embodiment of the invention, said optimization routine is arranged to distribute terminal resources to comply with said terminal constraints and said updated terminal resource demand and to optimize distribution of terminal resources with respect to one or more optimization targets.

In an embodiment of the invention, said optimization targets are said allocation targets.

Allocation target may advantageously be represented by the model(s) of the container carrier terminal system.

In an embodiment of the invention, said method comprises a step of operating said container carrier terminal by operating said terminal resources on the basis of said updated terminal resource plan.

In an embodiment of the invention, said step of operating said container carrier terminal comprises operating one or more of said plurality of quay cranes on the basis of said updated terminal resource plan.

In an embodiment of the invention, said step of operating said container carrier terminal comprises moving one or more of said plurality of quay cranes from a respective first quay crane position to a respective second quay crane position on the basis of said updated terminal resource plan.

By a first and second quay crane position is understood positions of a quay crane along a quay of the container carrier terminal. The first quay crane position may be a position along the quay where the quay crane has loaded/unloaded shipping containers from a first container carrier and the second quay crane position may be another position of the quay crane along the same quay where another container carrier is present and where loading/unloading of shipping containers is required. The first and second quay crane positions may also refer to positions of the crane adjacent to the same container carrier. For example, when a container carrier is berthing a redistribution of shipping containers may be needed, i.e. the quay crane may have to move a shipping container from one position to another position along the length of the container carrier.

In an embodiment of the invention, said step of allocating a respective subset of said terminal resources comprises identifying whether said allocated terminal resources comply with said preliminary terminal resource demand associated with said plurality of container carrier entries and providing at least one notice of violation when said allocated terminal resources does not comply with said preliminary terminal resource demand.

In some situations, it may not be possible to allocate terminal resources to a plurality of container carrier entries to comply with the preliminary terminal resource demand. The magnitude of the preliminary terminal resource demand may be greater than the terminal resources. E.g. the combined length of container carriers scheduled to lay along the quay be greater than the total length of the quay, or there may not be enough available quay cranes to fully load and unload all container carriers within their respective arrival and departure times.

Providing a notice of violations is advantageous, since it alerts a manager of a container carrier terminal that some type of adjustments may be necessary. Particularly, since embodiments of the invention are arranged to obtain a terminal resource plan far in advance of operation, providing a notice of violation allows adjustments of the container carrier terminal or of arrival and departure time, with minimal delays to delivery of containers to consumers and production facilities.

A notice of violation may for example be a message on a computer and may for example be provided to a user of the container carrier terminal system, e.g. a berth planner or manager of the container carrier terminal.

In an embodiment of the invention, said at least one notice of violation is a plurality of notices of violations, wherein each notice of violation of said plurality of notices of violations is provided for a respective subset of said preliminary terminal resource demand which does not comply with said allocated terminal resources.

In some situations, there may be multiple subsets of the preliminary terminal resource demand which cannot be met by the available terminal resources. For example, a lack of available quay cranes result in a temporary terminal resource plan in which multiple container carriers are not loaded and unloaded accordingly. A notice of violation may then be provided for each subset of the preliminary terminal resource demand, do not have allocated terminal resources.

Providing a dedicated notice of violation for each problem in a terminal resource plan is advantageous, since it alerts a manager of the container carrier terminal of each single problem.

In an embodiment of the invention, each notice of violation of said at least one notice of violation is provided together with one or more violation solution suggestions, wherein implementation of a violation solution suggestion of said one or more violation solution suggestions in said preliminary terminal resource plan result in said allocated terminal resources complying with said subset of said preliminary terminal resource demand.

In an embodiment of the invention, a violation solution suggestion of said one or more violation solution suggestions comprises changing any of said tentative arrival time, said tentative departure time, said terminal constraints, said preliminary terminal resource demand, and a quay crane efficiency.

A notice of violation may be provided together with violation solution suggestions. For example, if allocation of terminal resource cannot be performed such that a container is unloaded and/or loaded as required, a manager of the container carrier terminal may receive a number of violation solution suggestions. For example, a tentative arrival time of the container carrier/container carrier entry may be changes to allow sufficient quay crane operations. Or similarly, the tentative departure time may be changes. Other violations solution suggestions may for example be to suggestion loading and/or unloading fewer shipping containers, change a (scheduled) quay crane efficiency, call in additional gangs of workers, add overtime for a gang of workers etc.

A quay crane efficiency may for example be crane GMPH which is crane gross-moves per hour, which is indicative of how many shipping containers or units of TEU a quay crane can transfer per unit of time.

In an embodiment of the invention, said method comprises a step of identifying discrepancies between said allocated terminal resources and any of said tentative arrival time and said tentative departure time to provide at least one notice of possible reduction of emission if any of a difference between said tentative arrival time and a resource allocation start is larger than a premature arrival threshold, and a difference between said tentative departure time and a resource allocation end is larger than a late departure threshold.

A notice of possible reduction of emission may for example be a message on a computer and may for example be provided to a user of the computer implemented container carrier terminal system, e.g. a berth planner or manager of the container carrier terminal.

A resource allocation start may for example be the first point in time which a quay crane has been allocated to, in relation to a relevant container carrier entry. Similarly, a resource allocation end may for example be the last point int time which a quay crane has been allocated to, in relation to a relevant container carrier entry.

In some situations, it may be possible to change a tentative arrival time, such that a container carrier can reduce is cruising speed to reduce emission of greenhouse gases while cruising towards the container carrier terminal, while it is still possible to load and unload any required shipping containers. Or similarly, it may be possible to change a tentative departure time, such that a container carrier can reduce its cruising speed while cruising towards the next container carrier terminal on its container carrier route, while it is still possible to load and unload any required shipping containers.

It is advantageous to provide a notice of possible reduction of emission since it notices one or more users that a reduction of greenhouse gases is possible. For example, based on a preliminary terminal resource plan and such that an updated terminal resource plan can be established and/or processed.

In an embodiment of the invention, said at least one notice of possible reduction of emission is a plurality of notices of possible reductions of emission, wherein each notice of possible reduction of emission of said plurality of notices of possible reductions of emission is related to a respective occurrence of any of a difference between said tentative arrival time and said resource allocation start is larger than said premature arrival threshold, and a difference between said tentative departure time and said resource allocation end is larger than said late departure threshold.

In some situations, multiple reductions of emission are possible, and accordingly, multiple notices of possible reductions of emission are provided.

Providing a dedicated notice of possible reduction of emission for each time a reduction of emission is possible through rescheduling is advantageous, since this allows a user to handle to individual reductions.

In an embodiment of the invention, said premature arrival threshold is from 0 minutes to 600 minutes, for example from 5 minutes to 180 minutes, such as from 10 minutes to 120 minutes, such as 30 minutes or 60 minutes.

In an embodiment of the invention, said late departure threshold is from 0 minutes to 600 minutes, for example from 5 minutes to 180 minutes, such as from 10 minutes to 120 minutes, such as 30 minutes or 60 minutes.

In an embodiment of the invention, each notice of possible reduction of emission of said at least one notice of possible reduction of emission is provided together with at least one option of reduced emission.

In an embodiment of the invention, said at least one option of reduced emission comprises changing said tentative arrival time such that said difference between said tentative arrival time and said resource allocation start is smaller than said premature arrival threshold.

In an embodiment of the invention, said at least one option of reduced emission comprises changing said tentative departure time such that said difference between said tentative departure time and said resource allocation end is smaller than said late departure threshold.

Providing at least one option of reduced emission to a user is advantageous, since this informs the user of which possible solutions exit to reduce emission of greenhouse gases in a complex resource allocation environment.

As an example, a container carrier entry is associated with a tentative arrival time of 07:00 and a tentative departure time of 23:30, allocated terminal resources include a first quay crane which is allocated to a first crane time window from 09:00 to 19:00 and a second quay crane which is allocated to a second crane time window from 11:00 to 21:00, and a premature arrival threshold and a late departure threshold which are both 30 minutes. Thus, the resource allocation start is 09:00 and the resource allocation end is 21:00, and moreover, the difference between tentative arrival time and the resource allocation start is 120 minutes and between tentative departure time and the resource allocation end is 150 minutes. Here, the container carrier terminal system provides two notices of possible reductions of emission along with options of reduced emissions. The first option is to change the tentative arrival time from 07:00 to 8:30, and the second option is to change the tentative departure time from 21:00 to 19:30. Implementation of these result in the difference between resource allocation start and the tentative arrival time to be within the premature arrival threshold, and the difference between resource allocation end the tentative departure time to be within the late departure threshold. A manager may then, for example, contact the container carrier to agree upon these changes in tentative arrival and departure times. Operation of these arrival and departure times will result in a reduces emission of greenhouse gases, in comparison with operation according to the previous arrival and departure times.

In an embodiment of the invention, said container carrier terminal system comprises at least one resource scenario, wherein each resource scenario of said at least one resource scenario is a graphical representation of at least one resource plan of any of said preliminary terminal resource plan and said updated terminal resource plan.

In an embodiment of the invention, said at least one resource scenario is a plurality of resource scenarios comprising a master resource scenario and at least one auxiliary resource scenario, wherein said step of allocating a respective subset of said terminal resources is performed in one of said at least one auxiliary resource scenario, and wherein said master resource scenario is arranged to be updated on the basis of one of said at least one auxiliary resource scenarios.

In an embodiment of the invention, said step of operating said container carrier terminal is based on said master resource scenario comprising said updated terminal resource plan.

In an embodiment of the invention, each of said at least one auxiliary resource scenario is arranged to be edited by a user.

In an embodiment of the invention, each resource scenario of said at least one resource scenario is associated with one or more scenario efficiency parameters, wherein said one or more scenario efficiency parameters are automatically calculated and indicative of an estimated efficiency of an associated resource scenario.

A resource scenario may comprise a preliminary terminal resource plan, an updated terminal resource plan, or both.

A resource scenario may be understood as a potential terminal resource plan. A container carrier terminal system may for example comprise multiple resource scenarios, wherein the container carrier terminal is operated according to a master resource scenario of the resource scenarios. Alternative terminal resource plans may then be established as auxiliary resource scenarios and evaluated by a user. Upon generation of a preferable and/or more efficient terminal resource plan in an auxiliary resource scenario, the master resource scenario/master database may be updated by importing elements from that auxiliary resource scenario.

Having a resource allocation environment with multiple resource scenarios is advantageous, since it allows a user to test a multitude of various terminal resource planning strategies while maintaining a master resource scenario which the container carrier terminal is operated upon. As such, a better updated terminal resource plan can be established, with minimized risk of upsetting it.

Resource scenarios may for example be implemented in data processing equipment. They may for example have a graphical representation on a computer display. The different resource scenarios may for example be available in different tabs of a graphical user interface, which allows the user to quickly browse the various resource scenarios for comparison and optimization.

Scenario efficiency parameters may for example be indicative of crane allocation, gang allocation, idle time, etc.

In an embodiment of the invention, said step of allocating a respective subset of said terminal resources is performed with respect to a long-term time window.

In an embodiment of the invention, said providing an updated terminal resource demand is performed with respect to said long-term time window.

In an embodiment of the invention, said processing an updated terminal resource plan is performed with respect to said long-term time window.

In an embodiment of the invention, said long-term time window comprises at least one tentative arrival time of said plurality of container carrier entries.

In an embodiment of the invention, said long-term time window is from 2 days to 90 days, for example from 3 days to 60 days, such as from 5 days to 30 days, such as from 7 days to 14 days.

A step of the method of the invention performed with respect to a long-term time window may be understood as performing the step taking into account elements of the container carrier terminal and/or container carrier entries. For example, a respective subset of terminal resources is allocated to a terminal resource demand of a container carrier entry which has a tentative arrival time which is 14 days into the future.

Thus, the long-term time window lies relative of performing a relevant step of the method. E.g. in an embodiment of the invention, a long-term time window is from 7 to 14 days, and the step of processing an updated terminal resource plan is performed with a container carrier entry which has a tentative arrival time which lies 12 days after processing the updated terminal resource plan.

Performing steps of the method is not restricted to container carrier entries with tentative arrival times which lie within the long-term time window. In an embodiment of the invention, providing an updated terminal resource demand is performed with respect to container carrier entries which have tentative arrival times before, during, and after the long-term time window.

In an embodiment of the invention, said step of allocating is at least partly based on said tentative arrival times of said preliminary terminal resource demands.

It may be advantageous to take the tentative arrival times into consideration when allocating subsets of terminal resources to the container carrier entries. Thereby it may be determined which container carrier entries demand resources at the same time, neighboring times or are not related in time. The consideration of tentative arrival time may preferably be enhanced by also taking into account the expected duration and/or a tentative departure time. In preferred embodiments, the allocation is further based on other preliminary terminal resource demands and/or terminal constraints.

In an embodiment of the invention, said step of validating comprises establishing whether said allocated terminal resources comply with said tentative arrival times of said preliminary terminal resource demands.

In order to evaluate whether the established preliminary terminal resource plan may be problematic with respect to compliance between resources, demands and constraints, it may be advantageous to take into consideration the tentative arrival times comprises by the demands of container carrier entries, thereby making it possible to consider potential problems with the allocation for a specific point in time. For example, it may be possible when taking into account the tentative arrival time, which may be derived from other time values such as tentative departure time, estimated time of arrival, etc., to sum up how many cranes have been allocated for a specific date and time and compare with the total amount of cranes in the terminal.

In an embodiment of the invention, said step of allocating said respective subset of said terminal resources is restricted to a subset of said plurality of container carrier entries.

In an embodiment of the invention, said optimization routine is restricted to a subset of said plurality of container carrier entries when performing optimization.

In an embodiment of the invention, said step of processing an updated terminal resource plan is restricted to a subset of said plurality of container carrier entries when performing optimization.

In berth planning, allocation of terminal resources may only be relevant for a subset of a plurality of container carrier entries. Other container carrier entries may for example be less relevant since the associated container carriers are scheduled to arrive relatively too far into the future. Or perhaps a berth planner has already made decided resource allocations for some container carrier entries, and does not want to alter this particular allocation.

In such cases, it is useful to only address a subset of the plurality of container carrier entries when allocating, optimizing, and/or processing. Thus, allocation or reallocation or resources can be avoided for entries for which such actions are not desired.

The subset of container carrier entries may for example be selected by a berth planner through a graphical user interface, e.g. by manually picking out entries on the user interface for which allocation, optimization, and/or processing are to be performed, or, alternatively, by picking out entries for which such actions should be not be performed.

The invention further relates to a container carrier terminal system comprising data processing equipment configured to execute a model of a container carrier terminal, said model comprising representations of terminal resources and terminal constraints relating to said terminal resources; said terminal resources comprising a plurality of quay cranes and said representations of terminal resources including representations of said plurality of quay cranes;
the container carrier terminal system comprising an input configured to receive a plurality of container carrier entries, each container carrier entry relating to a container carrier and associated with a preliminary resource demand including a tentative arrival time, wherein said tentative arrival time is indicative of arrival of said container carrier to said container carrier terminal;
the container carrier terminal system being configured to allocate a respective subset of said terminal resources to each container carrier entry of said plurality of container carrier entries to obtain a preliminary terminal resource plan of allocated terminal resources, wherein said allocation comprises automatically validating and/or distributing terminal resources, including said plurality of quay cranes, to said plurality of container carrier entries to comply with said terminal constraints and said preliminary terminal resource demand associated with said plurality of container carrier entries; and
the container carrier terminal system being configured to process an updated terminal resource plan on the basis of an updated terminal resource demand relating to said plurality of container carrier entries.

In an embodiment of the invention, container carrier terminal system of the invention is configured to carry out the method of the invention or any of its embodiments.

The invention further relates to a container carrier terminal comprising a plurality of quay cranes and the container carrier terminal system of the invention or any of its embodiments.

In an embodiment of the invention, the container carrier terminal is configured to operate said plurality of quay cranes on the basis of said updated terminal resource plan.

The invention further relates to a computer program comprising instructions which, when the program is executed by a computer, cause the computer to carry out the following steps:
execute a model of a container carrier terminal, said model comprising representations of terminal resources and terminal constraints relating to said terminal resources; said terminal resources comprising a plurality of quay cranes and said representations of terminal resources including representations of said plurality of quay cranes;
receive via an input a plurality of container carrier entries, each container carrier entry relating to a container carrier and associated with a preliminary resource demand including a tentative arrival time, wherein said tentative arrival time is indicative of arrival of said container carrier to said container carrier terminal;
allocate a respective subset of said terminal resources to each container carrier entry of said plurality of container carrier entries to obtain a preliminary terminal resource plan of allocated terminal resources, wherein said allocation comprises automatically validating and/or distributing terminal resources, including said plurality of quay cranes, to said plurality of container carrier entries to comply with said terminal constraints and said preliminary terminal resource demand associated with said plurality of container carrier entries; and
process an updated terminal resource plan on the basis of an updated terminal resource demand relating to said plurality of container carrier entries.

In an embodiment of the invention, the computer program further comprises instructions to cause the computer to carry out the following step: operating said plurality of quay cranes on the basis of said updated terminal resource plan.

In an embodiment of the invention, the computer program further comprises instructions to cause the computer to carry out the method of any of the invention or any of its embodiments.

### THE DRAWINGS

Various embodiments of the invention will in the following be described with reference to the drawings where

FIG. 1 illustrates a container carrier to be operated according to embodiments of the invention,

FIG. 2 illustrates the relationship between a container carrier and a so-called container carrier entry,

FIG. 3 illustrates exemplary hardware properties related to a container carrier terminal system according to embodiments of the invention,

FIG. 4 discloses and explains ways of organizing data records in embodiments a container carrier terminal system within the scope of the invention,

FIG. 5a-5c illustrate an exemplary graphical user interface which may be applied in a container carrier terminal system within the scope of the invention,

FIG. 6 illustrates some basic principles of a container carrier entry,

FIG. 7 illustrate how container carrier entries may very over time,

FIG. 8 illustrates how container carrier entries may very over time relative to the time at the final execution,

FIG. 9 illustrates a progressive update of terminal resource plans within the scope of the invention,

FIG. 10 illustrates how terminal resources may be affected during operation of a terminal,

FIG. 11 illustrates the use of ghost entry/entries within the scope of the invention and where

FIG. 12. illustrates the use of multiple scenarios when modifying specified entries for fitting into terminal resource plan.

### DETAILED DESCRIPTION

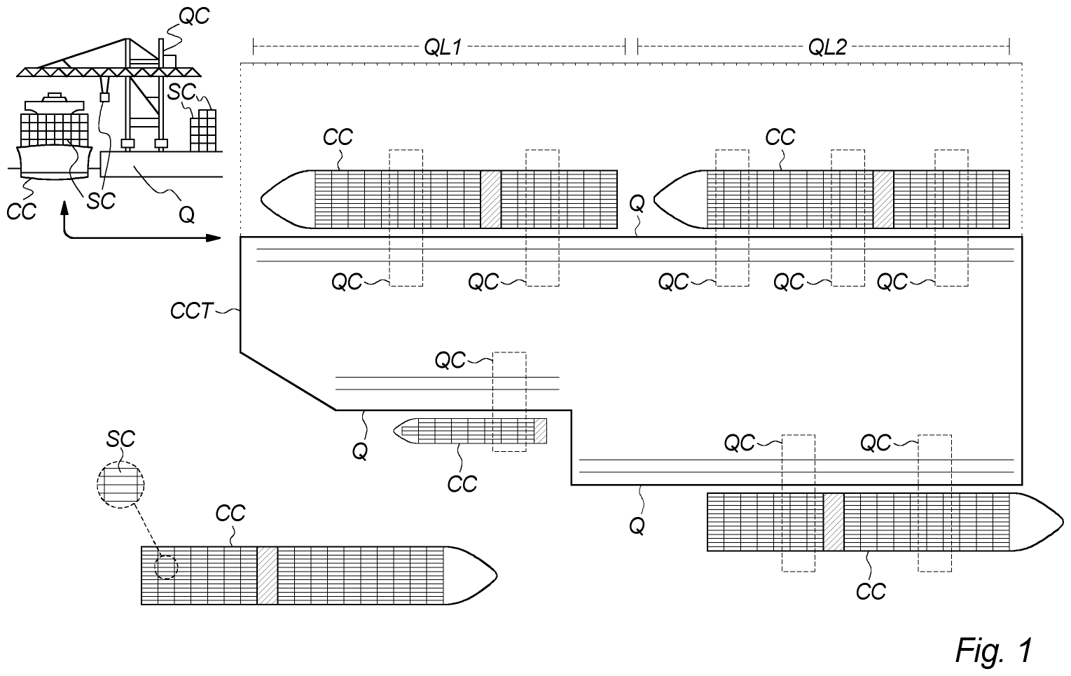

FIG. 1 illustrates a container carrier terminal CCT for handling container carriers CC of different sizes according to embodiments of the invention. The container carrier terminal CCT comprises three quays Q at which container carriers Q may berth, as well as a plurality of quay cranes QC disposed at the quays Q. As shown in FIG. 1, four container carriers CC are currently berthing at the container carrier terminal CCT at the quays Q of the container carrier terminal CCT and being serviced by the quay cranes QC.

The figure additionally illustrates a side view of one of the container carriers CC and one of the quay cranes QC.

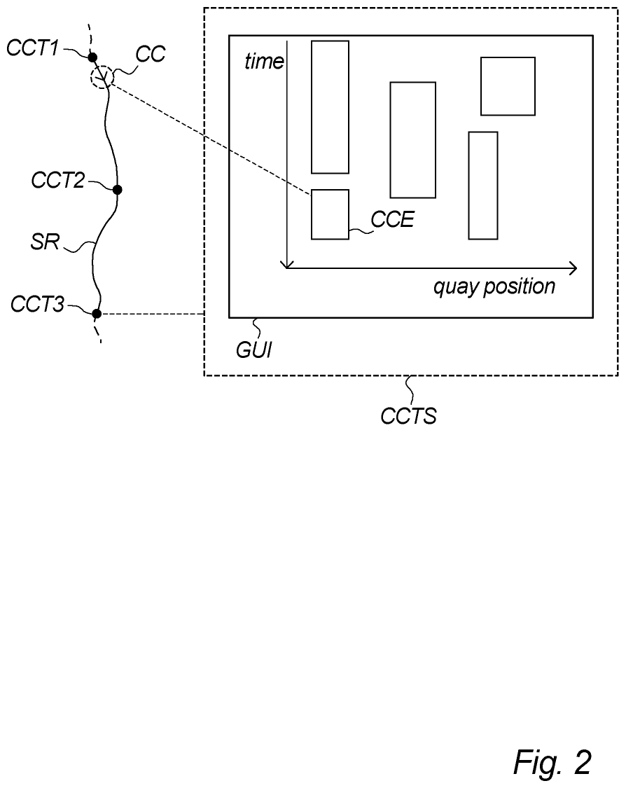

FIG. 2 illustrates a relationship between a container carrier CC and a container carrier entry CCE according to embodiments of the invention. As shown in the figure, a container carrier CC is sailing along a sailing route SR which includes stops, or port calls, at three container carrier terminals CCT1-CCT3. At each container carrier terminal, shipping containers are loaded, unloaded, and/or redistributed on the container carrier CC. As shown, the third container carrier terminal CCT3 is associated with a container carrier terminal system CCTS that is used for scheduling the logistics of the operations of the third container carrier terminal CCT3, including allocation of terminal resources to container carriers destined for arrival and berthing at the third container carrier terminal CCT3. As the container carrier CC is destined for arrival and berthing at the third container carrier terminal CCT3, a digital representation of the container carrier CC is present in the container carrier terminal system CCTS in the form of a container carrier entry CCE. As shown, the container carrier terminal system CCTS comprises a graphical user interface GUI which shows a graphical representation of the container carrier entry CCE.

The container carrier entry CCE comprises a tentative arrival time and a tentative departure time which is depicted in the graphical user interface GUI.

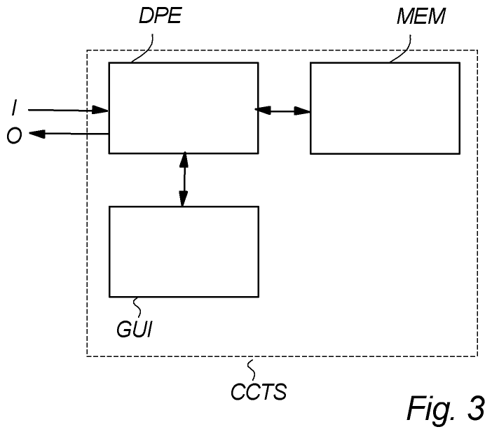

FIG. 3 illustrates a hardware setup of a container carrier terminal system CCTS within the scope of the invention. The container carrier terminal system CCTS comprises data processing equipment DPE. The data processing equipment here communicates with associated hardware memory MEM. The memory may be part of a device, apparatus or structure including the data processing equipment is located or it may be cloud based. The data processing equipment DEP is communicating with the outside world via an input I and a user interface GUI. It should be noted that the physical implementation of either input or output may very depending on whether inputs are merely channeled to the data processing equipment DPE e.g. via dedicated communication link as shown here, or it may be communicated to and from the outside world via a user interface including a graphical user interface GUI as shown here.

Other ways of structuring the physical data processing may be applied within the scope of the invention as long as the inventive provisions are applied and executed by means of the physical system.

It should also be noted that data bases may be applied for containing and processing both a preliminary and an updated terminal resource plan or plans.

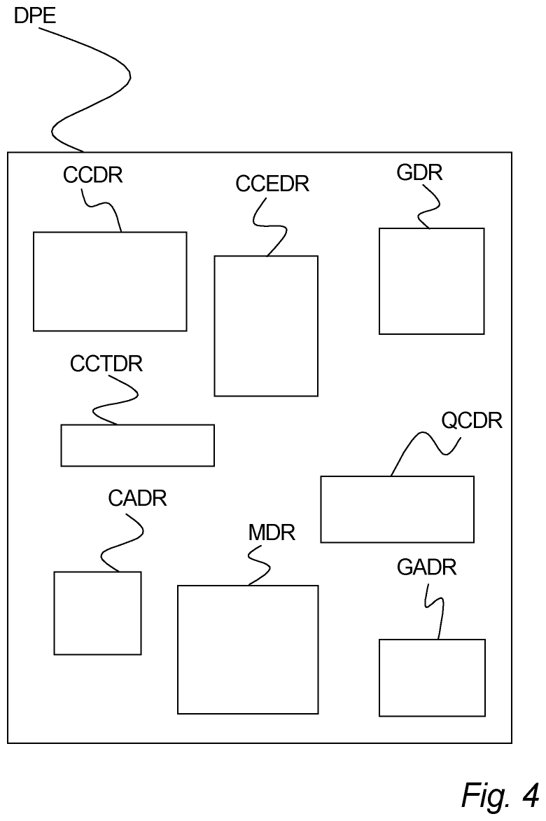

FIG. 4 illustrates data processing equipment DPE comprising different records of relevance to embodiments of the invention. Data processing equipment DPE may for example be one or more computers/servers, for example based on cloud storage.

The data processing equipment DPE comprises at least one or more crane allocation data records CADR, one or more container carrier entry data records CCEDR, one or more container carrier data records CCDR, one or more gang data records GDR, one or more maintenance data records MDR, one or more container carrier terminal data records CCTDR, one or more gang allocation data records GADR, and one or more quay crane data records QCDR.

A quay crane data record QCDR may be understood as a digital record of a quay crane. In this exemplary embodiment, this record comprises the information shown here:

| Field | Value |
|---|---|
| ID | 1 |
| Name | QC01 |
| Height | 53 meters |
| Outreach | 70 meters |
| Range from | 100 meters |
| Range to | 800 meters |

A container carrier data record CCDR may be understood as a digital record of a container carrier. In this exemplary embodiment, this record comprises the information shown here:

| Field | Value | |
|---|---|---|
| ID | 123 | |
| IMO | 9778791 | |
| Name | Madrid Maersk | |
| Length | 399 | meters |
| Beam | 58.6 | meters |
| Total cargo capacity | 20,568 | TEU |

A container carrier entry data record CCEDR may be understood as a digital record of a container carrier entry. In this exemplary embodiment, this record comprises the information shown here:

| Field | Value |
|---|---|
| ID | 123 |
| Vessel_ID | 123 |
| Service | Asia Europe (AE10) |
| Moves Load | 200 |
| Moves reload | 400 |
| Moves redistribute | 50 |
| GMPH | 30 |
| Target vessel rate | 80 |
| Pilot station arrival | 2/4/2020 11:00 |
| Berth arrival | Feb. 4, 2020 12:00 |
| Cargo start | Feb. 4, 2020 12:00 |
| Cargo end | Feb. 4, 2020 18:00 |
| Berth departure | Feb. 4, 2020 18:10 |
| Maximum cranes | 6 |
| Quay start | 400 |
| Quay end | 799 |

Here, the berth arrival or the cargo start may for example be the tentative arrival time, and the berth departure or the cargo end may be the tentative departure time.

A crane allocation data record CADR may be understood as a digital record of a crane allocation/quay crane allocation. In this exemplary embodiment, this record comprises the information shown here:

| Field | Value |
|---|---|
| Crane_ID | 1 |
| Port call: | 123 |
| Start | Feb. 4, 2020 12:00 |
| End | Feb. 4, 2020 18:00 |

Here, the port call may be understood as the container carrier entry.

A maintenance data record MDR may be understood as a digital record of a maintenance, e.g. a maintenance of a quay crane or a part of a quay. In this exemplary embodiment, this record comprises the information shown here:

| Field | Value |
|---|---|
| Crane_ID | 1 |
| Maintenance type | Corrective maintenance |
| Start | Jan. 2, 2020 11:00 |
| End | Jan. 2, 2020 23:00 |

A gang data record GDR may be understood as a digital record of a gang of workers. In this exemplary embodiment, this record comprises the information shown here:

| Field | Value |
|---|---|
| Gang_ID | 2 |
| Number of workers | 10 |
| Regular shift start | 8:00 |
| Regular shift end | 16:00 |

A gang allocation data record GADR may be understood as a digital record of an allocation of a gang, e.g. to a quay crane. In this exemplary embodiment, this record comprises the information shown here:

| Field | Value |
|---|---|
| Gang_ID | 2 |
| Crane_ID | 1 |
| Port call | 123 |
| Allocation start | Feb. 4, 2020 12:00 |
| Allocation end | Feb. 4, 2020 16:00 |

A container carrier terminal data record CCTDR may be understood as a digital record of a container carrier terminal. In this exemplary embodiment, this record comprises the information shown here:

| Field | Value |
|---|---|
| terminal_ID | 321 |
| Number of gangs 8:00-16:00 | 10 |
| Number of gangs 16:00-24:00 | 8 |
| Number of gangs 00:00-08:00 | 6 |
| Number of cranes | 8 |
| Quay length | 1000 meters |
| Allocation end | 2/4/2020 16:00 |

The above examples of records should be seen as exemplary. Any records according to embodiments of the invention may comprise any information and be linked in any manner within the scope of the invention as defined by the claims.

In particular, it should be mentioned that quay crane records and/or their associated maintenance within the scope of the present invention may be represented in numerous different ways as long as the allocation of a terminal resource in the form of a quay crane may be allocated in the system for use in connection with container carriers and their respective associated container carrier entries. It should also be noted that the maintenance and preferably also restrictions/constraints resulting from a planned maintenance related to e.g. cranes and/or berth should be contained and be processable to a degree that makes it possible to automatically calculate/validate whether the a planned maintenance of one terminal resource affect the functioning/applicability of further non-maintained resources.

Such constrictions may be applied or contained in separate records but they may e.g. also be contained in relevant resource records. An example of such may be a crane record including e.g. location at where the crane is or is to be maintained and also an information of whether the crane can be moved. This has the effect that a crane which is down for breakdown maintenance may be identified as non-movable and therefore blocking for movement of neighboring cranes and therefore making these neighboring cranes non-usable or restricted during maintenance. Other such “cross” terminal resource constraints may be applied or included for automatic calculation/validation of applicability of terminal resources, i.e. whether these are available or to what degree they are available.

In particular, it should be mentioned that quay crane records and/or their associated maintenance within the scope of the present invention may be represented in numerous different ways as long as the allocation of a terminal resource in the form of a quay crane may be allocated in the system for use in connection with container carriers and their respective associated container carrier entries. It should also be noted that the maintenance and preferably also restrictions/constraints resulting from a planned maintenance related to e.g. cranes and/or berth should be contained and be processable to a degree that makes it possible to automatically calculate/validate whether the a planned maintenance of one terminal resource affect the functioning/applicability of further non-maintained resources.

Such constrictions may be applied or contained in separate records but they may e.g. also be contained in relevant resource records. An example of such may be a crane record including e.g. location at where the crane is or is to be maintained and also an information of whether the crane can be moved. This has the effect that a crane which is down for breakdown maintenance may be identified as non-movable and therefore blocking for movement of neighboring cranes and therefore making these neighboring cranes non-usable or restricted during maintenance. Other such “cross” terminal resource constraints may be applied or included for automatic calculation/validation of applicability of terminal resources, i.e. whether these are available or to what degree they are available.

An exemplary model which may be applied in a container carrier terminal system within the scope of the invention is disclosed and explained below. Other types of models and optimizations of such may be applied widely within the scope of the invention.

The model described below may also be referred to as a berth optimization model, as the model facilitates optimization of the operation of a terminal operating according to the progressing updated terminal resource plan in compliance and by means of the overall combined model. Here and elsewhere it should be noted that a port call corresponds to a container carrier entry according to the provisions of the invention and that the below referred set of all port calls P may refer to the elsewhere referred plurality of container carrier entries CCE. In the same way, arrival time may refer to what is elsewhere in the application mentioned as tentative arrival time. Please also note that time slots in the below model/models refers to units of time slots of one hour rather referring to a complete time window. A time window may thus be defined by one or a plurality of time slots.

Sets and Parameters

First sets and parameters are outlined:

| | |
|---|---|
| P | Set of all port calls |
| B | Set of all berth positions. A berth position is defined by a quay location, an arrival time, and a |
| | departure time |
| B^{p} ⊂ B | Set of all feasible berth positions for port call p ∈ P. To determine this set, we consider charac- |
| | teristics such as how many and what kind of cranes can reach this position |
| P [symbol] ⊂ P | Set of all port calls that can be assigned to berth position b ∈ B |
| wₚₕ | penalty associated wish allocating port call p ∈ P to berth position b ∈ B [symbol] |
| b [symbol] | arrival time of berth position b ∈ B |
| I | Set of painwise incompatible berth positions. If (b₁, b₂,) ∈ I, with b₁, b₂ ∈ B, then any feasible |
| | solution cannot contain port calls in both b₁ and b₂ |
| O | Pairwise precedence set, defining the order in which port calls should berth. If a pair of port |
| | calls (p₁, p₂) ∈ O, this means that the berth position selected for port call p₁ should have an |
| | earlier arrival time than the berth position selected for port call p₂ |

[symbol]

indicates data missing or illegible when filed

We consider several different aspects to calculate wₚₕ:
difference between the position of b and the desired position of port call p
difference between the arrival time of b and the desired arrival time of port call p
number of cranes that can reach position b
characteristics of the cranes that can reach position b, in terms of productivity, range, and outreach
yard driving distances to pick up containers to be loaded on the port call
   All these items have different weights in their contribution to wₚₕ.|

Variables

| | |
|---|---|
| [symbol] ∈ [0, 1] | Binary variables, equal to 1 if and only if port call p ∈ P is |
| | assigned to berth position b ∈ B^{p} |

[symbol]

indicates data missing or illegible when filed

Objective Function and Constraints

The exemplary mathematical model for Berth Optimization is presented below:

$$min {\sum }_{p ∈ P} {\sum }_{b ∈ {H}^{p}} {w}_{pb} \cdot {x}_{pb} \qquad ( 1 )$$

$$s . t . {\sum }_{b ∈ {B}^{υ}} {x}_{pb} = 1 \qquad ( 2 )$$

$$∀ p ∈ P$$

$${\sum }_{\text{?}} {x}_{{ph}_{1}} + {\sum }_{\text{?}} {{x}_{p b}}_{2} \leq 1 \qquad ( 3 )$$

$$∀ ( {b}_{1} , {b}_{2} ) ∈ I$$

$${\sum }_{\text{?}} \text{?} \cdot \text{?} < {\sum }_{\text{?}} {x}_{pgb} \cdot \text{?} \qquad ( 4 )$$

$$∀ ( {p}_{1} , {p}_{2} ) ∈ O$$

$${x}_{pb} ∈ \{ 0 , 1 \} \qquad ( 5 )$$

$$∀ p ∈ P , b ∈ {B}^{p}$$

$$\text{?} \text{indicates text missing or illegible when filed}$$

The objective function (1) minimizes the penalties associated with the berth positions chosen for each port call. Constraints (2) ensure that we select exactly one berth position for each port call. Constraints (3) ensure that incompatible berth positions are not selected simultaneously, ensuring conflict free solutions. Constraints (4) ensure that the priorities between port calls are respected. Finally, constraints (5) define the domain of the decision variables.

Sets and Parameters

Furthermore, the overall model may include a crane optimization model:

| | |
|---|---|
| P | Set of all port calls |
| pₕ | Minimum number of crane hours to be assigned to port call p ∈ P, determined based in the |
| | number of moves to be performed |
| p [symbol] | Maximum number of cranes that can be assigned to port call p ∈ P in the same time slot, |
| | determined by vessel characteristics |
| C | Set of all cranes |
| C [symbol] ⊂ C | Set of all cranes that can be assigned to port call p ∈ P. This takes into account crane charac- |
| | teristics such as range, productivity, or crane height, and port call characteristics such as vessel |
| | length, vessel beam, and position of the port call |
| T | Set of all time slots in the planning horizon, being a time slot equal to 1 hour |
| T^{p} ⊂ T | Set of all time slots overlapping the port stay of port call p ∈ P |
| P [symbol] ⊂ P | Set of all port calls that contain time slot t ∈ T in their port stay |
| S | Set of all shifts in the planning horizon |
| T [symbol] ⊂ T | Set of all time slots of shift [symbol] ∈ S |
| [symbol] | Cost of using a gang in shift [symbol] ∈ S |

[symbol]

indicates data missing or illegible when filed

Variables

| | |
|---|---|
| [symbol] ∈ {0, 1} | Binary variables, equal to 1 if and only if crane c ∈ C^{p} is |
| | assigned to port call p ∈ P in time slot t ∈ T^{p} |
| [symbol] ∈ [symbol] | Positive integer variables, representing the number of gangs |
| | used in shift [symbol] ∈ S |

[symbol]

indicates data missing or illegible when filed

Objective Function and Constraints

The exemplary mathematical model for Crane Optimization is presented below:

$$min {\sum }_{s ∈ S} \text{?} \cdot \text{?} \qquad ( 6 )$$

$$s . t . {\sum }_{\text{?}} {\sum }_{\text{?}} \text{?} \geq {p}_{h} \qquad ( 7 )$$

$$∀ p ∈ P$$

$${\sum }_{{{\text{?}}_{}}^{}} \text{?} \leq {p}_{max C} \qquad ( 8 )$$

$$∀ p ∈ P , t ∈ {T}^{p}$$

$${\sum }_{\text{?}} {\sum }_{c ∈ {C}^{p}} \text{?} \leq \text{?} \qquad ( 9 )$$

$$∀ s ∈ S , t ∈ \text{?}$$

$$x \text{?} ∈ \{ 0 , 1 \} \qquad ( 10 )$$

$$∀ p ∈ P , c ∈ {C}^{p} , t ∈ {T}^{p}$$

$$\text{?} ∈ {ℤ}_{0}^{+} \qquad ( 11 )$$

$$∀ \text{?} ∈ S$$

$$\text{?} \text{indicates text missing or illegible when filed}$$

The objective function (6) minimizes the costs associated with the gangs used in all shifts in the planning horizon. Constraints (7) ensure that we have enough crane hours assigned to each port call. Constraints (8) ensure that at each time slot, the maximum number of cranes for each port call is respected. Constraints (9) determine the number of gangs used in each shift. Finally, constraints (10) and (11) define the domain of the decision variables.

The two above models may be applied in combination according to the provisions of the invention for automatically validating of container carrier entries and associated allocated terminal resources. Optimization may thus be applied for both berth positions and crane allocations. Further models may be included e.g. to describe and optimize with respect to internal terminal logistics, container distribution at the terminal etc.

The models may also be applied for optimization by validation of manual input of alternative configurations of one or groups of containers carrier entries. An a particular advantageous embodiments of the invention, the models or variations thereof may be applied for automatically suggesting modifications of particular entries and also for suggesting modifications of container carrier entries affected by a first modification of an entry leading to conflict with the particular entries.

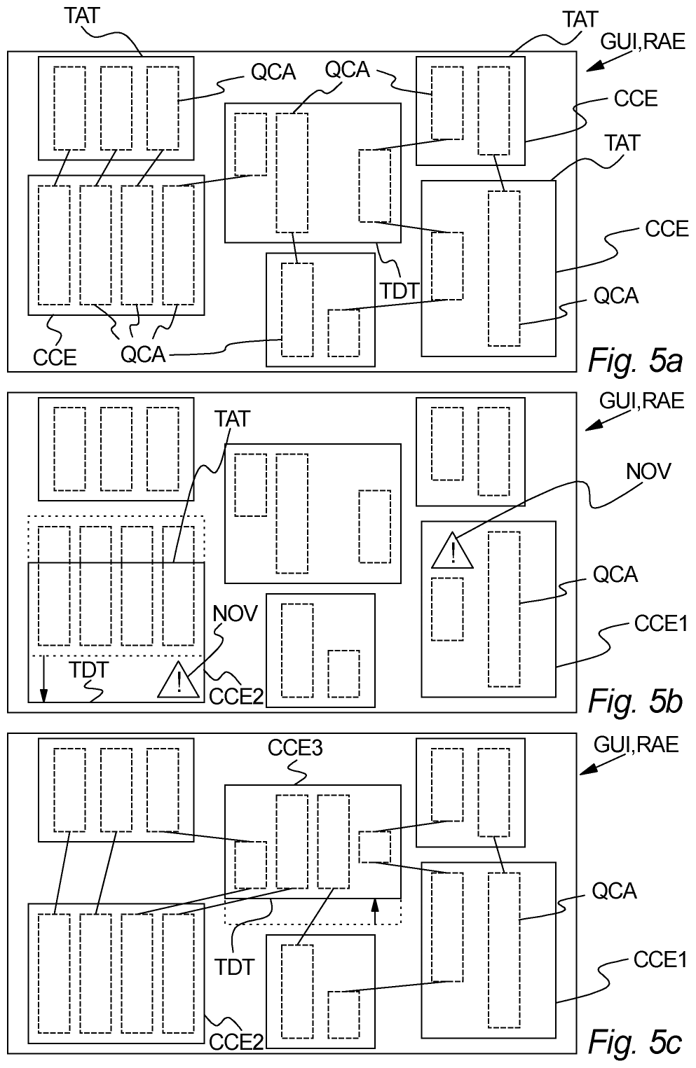

FIG. 5a-5c illustrate allocation of terminal resources, providing an updated terminal resource demand, and processing an updated terminal resource plan, e.g. reallocation of terminal resources. Each of the subfigures, 5a, 5b, and 5c is a graphical user interface GUI showing a representation of a resource allocation environment RAE. The vertical direction in each of the subfigures indicate time, and the horizontal direction indicate position along the quay of the container carrier terminal.

The graphical user interface GUI showing the resource allocation environment RAE is part of a container carrier terminal system and allows a user to allocate and monitor container carrier entries and quay crane allocation QCA with respect to these container carrier entries CCE. In the graphical user interface, the location and extend of a container carrier entry in the horizontal direction indicate an allocated quay location and quay length of the container carrier entry and its associated container carrier. The location and extend of a container carrier entry CCE along the vertical direction indicate the tentative arrival time TAT and tentative departure time TDT. In this embodiment, the shown plan is executed from top to bottom, i.e. the arrow of time and the time axis points downwards.

In FIG. 5a, a plurality of container carrier entries CCE are shown in in the graphical user interface GUI. A total of seven cranes have been allocated to these container carrier entries according to an embodiment of the invention. That is, the quay cranes have been automatically allocated to the container carrier entries to comply with their preliminary terminal resource demand and their tentative arrival and departure time. In the graphical user interface GUI, each quay crane allocation QCA is indicated by a rectangle located in relation to a container carrier entry CCE. Allocation of a single quay crane to several quay crane allocations QCA is indicated by lines extending between these quay crane allocations QCA.

The various quay crane allocations QCA of an individual container carrier entry CCE does not necessarily have the same extend. The summarized extend of the quay crane allocations QCA of a given container carrier entry ensure that the terminal resource demand of the container carrier entry is met. For example, a container carrier which is expected to have relatively many shipping containers loaded and/or unloaded has a larger summarized extend of quay crane allocations QCA than a container carrier which is expected to have relatively fewer shipping containers loaded and/or unloaded.

Note that the maximum number of quay cranes associated with a container carrier/container carrier entry is not necessarily allocated to a container carrier entry. For example, a container carrier may be arranged to have four quay cranes to simultaneously perform transfer of containers, but only three are allocated.

In this embodiment, the allocation is performed based on crane allocation constraints. For example, quay cranes are not allocated such that they are required to cross each other along the quay during operation. Further, each quay crane is not allocated to more than one crane time window at a time. Additionally, the allocation has been performed with respect to a built-in movement time of cranes between different positions along the quay. However, note that embodiments of the invention are not restricted to particular crane allocation constraints.

In some embodiments, the allocation is performed at least partially manually. In some embodiments, the allocation is performed automatically. The allocation may further be based on an optimization, for example an optimization to maximize the potential reduction of greenhouse gases by minimizing the potential expected durations 13 of the container carrier entries 6.

The shown allocation of quay cranes to container carrier entries CCE is an example of a preliminary terminal resource plan. It may for example have been established several weeks prior to the tentative arrival time of any of the entries shown in the graphical user interface.

In FIG. 5b, a later version of the terminal resource plan as shown in FIG. 5a is shown. In FIG. 5b, the container carrier terminal system has received an updated terminal resource demand. A container carrier associated with a first container carrier entry CC1 have informed that more shipping containers requires to be unloaded than previously expected. Consequently, the current quay crane allocation is insufficient. In such cases, the container carrier terminal system is arranged to provide a notice of violation NOV, which is shown in the graphical user interface GUI and which is linked to the container carrier entry CCE1. The user may digitally interact with this notice of violation to receive information about the violation and to receive violation solution suggestions. The displaying of notice of violation NOV may advantageously be based on the automatically performed validation of entry/entries as described further in detail elsewhere in the present application.

Additionally, another container carrier associated with a second container carrier entry have informed that the container carrier is delayed and will arrive later than previously expected. In the graphical user interface, the container carrier entry CCE2 have been shifted downwards corresponding to the delay, such that the tentative arrival time TAT and the tentative departure time are both later. Consequently, the quay crane allocations QCA do no longer lie properly within the container carrier entry. Since the parts of the quay crane allocations QCA which lie within the container carrier entry CCE2 are insufficient to perform the expected loading and unloading of containers, a notice of violation NOV is provided and shown in the graphical user interface GUI and linked to the container carrier entry CCE2.

Upon receiving the updated tentative arrival time and terminal resource demand, the preliminary terminal resource plan of allocated terminal resource does no longer comply with the terminal resource demand. Accordingly, the plan can be updated to establish an updated terminal resource plan.

In FIG. 5c, terminal resources have been redistributed. The principles of this new allocation of quay cranes is substantially similar to the principles used for the quay crane allocation illustrated in FIG. 5a, but the updated container carrier entries and updated terminal resource demands have been used. For example, the quay cranes have been allocated using similar constraints.

The new quay crane allocations QCA shown in FIG. 5c have ensured that the allocated terminal resource, including the quay cranes, comply with the updated terminal resource demand. Further, the delay of the container carrier associated with a container carrier entry CCE2 have enables quay crane allocation to be redistributed in a manner which allow a third container carrier associated with a third container carrier entry CCE3 to be unloaded and loaded more quickly, such that its tentative departure time lies earlier. This ensures that this container carrier may reduce its cruising speed towards the next container carrier terminal to reduce emission of greenhouse gases.

As such, the processing of an updated terminal resource plan on the basis of an updated terminal resource demand be means of the computer implemented container carrier terminal system have ensured that cargo, which could otherwise be greatly delayed, may be properly loaded and unload in the container carrier system, while simultaneously reducing emission of greenhouse gases.

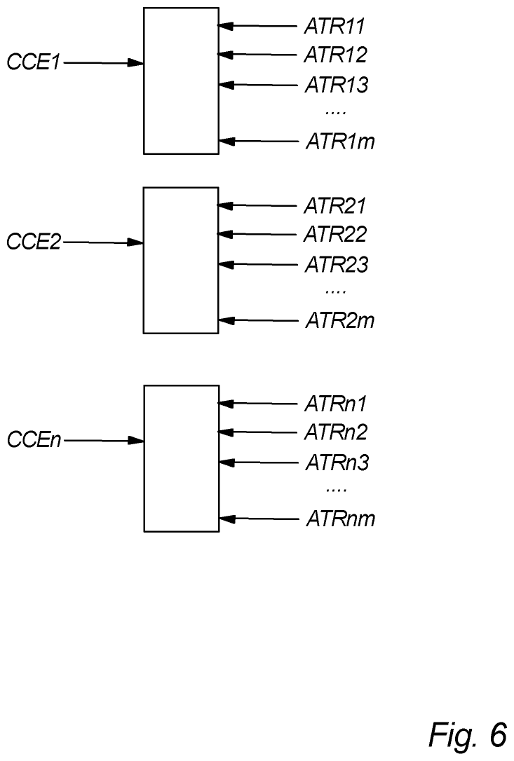

FIG. 6 illustrates some principles relating to the understanding of a representation of terminal resources and how these are allocated to container carrier entries.

The figure shows how a number of container carrier entries CCE1, CCE2, CCEn are each associated with corresponding representations of terminal resources.

Thus, a first container carrier entry CCE1, e.g. a specific carrier or a carrier having specified properties, is allocated corresponding terminal resources here described by representations of terminal resources ATR11, ATR12, ATR13 . . . ATR1m.

A second container carrier entry CCE2, also a specific carrier or a carrier having specified properties, is allocated corresponding terminal resources here described by representations of terminal resources ATR21, ATR22, ATR23 . . . ATR2m, etc.

All resources are associated with respective specified time slots and a subset of terminal resources are allocated for the purpose of fulfilling the requirement of a demand related to the respective entries.

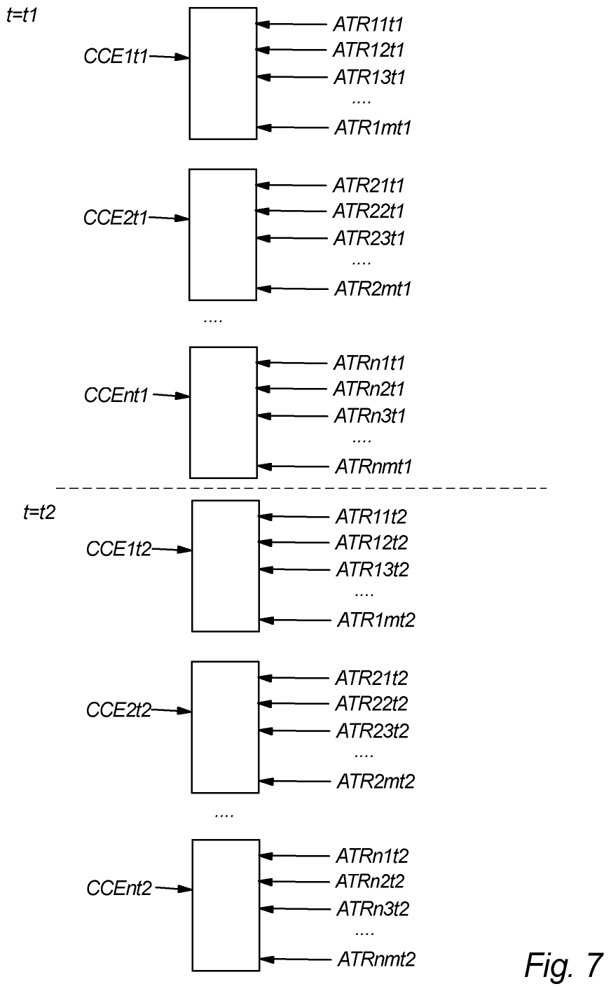

FIG. 7 illustrates some principles relating to the understanding of a representation of terminal resources and how these are allocated to container carrier entries over time.

The figure shows how a number of container carrier entries CCE1t1, CCE2t1, CCEnt1 each are associated with corresponding representations of terminal resources at a given time t1.

Thus, a first container carrier entry CCE1t1, e.g. a specific carrier or a carrier having specified properties, is allocated corresponding terminal resources here described by representations of terminal resources ATR11t1, ATR12t1, ATR13t1 . . . ATR1mt1 at the time t1.

A second container carrier entry CCE2t1, also a specific carrier or a carrier having specified properties, is allocated corresponding terminal resources here described by representations of terminal resources ATR21t1, ATR22t1, ATR23t1 . . . ATR2mt1 at the same time t1.

All resources are associated with respective specified time slots and a subset of terminal resources are allocated for the purpose of fulfilling the requirement of a demand related to the respective entries at the given time t1. It should be noted that that allocated resources may include time slots, including at least specification of absolute time so that conflict may be avoided between allocated resources. It should also be noted that the time slots are future to the time t1 in the present context. In other words, the allocated terminal resources are here specified and stored as they are determined to be in the future at the “present” time t1.

At the time t2 updated carrier entries container CCE1t2, CCE2t2, CCEnt2 are input related to future demands. It should be noted that the applied carriers entries as they are defined at time t2, may or may not differ from the earlier entries at time t1 and the same applies to the allocated resources ATR21t2, ATR22t2, ATR23t2 . . . ATR2mt2. It should however be noted that just one change in either, a modified entry or a modification in the description or constraints related to available terminal resources preferably should invoke an updating of the updated terminal resource demand relating to the entries unless special circumstances are defined as a room for accepting e.g. latency with respect to updating of the terminal resource plan. Other triggers for updating allocated resource may e.g. be invoked by a user of the system activating an automated optimization procedure, if such procedure is facilitated by the system.

At the time t2 updated carrier entries container CCE1t2, CCE2t2, CCEnt2 are input related to future demands. It should be noted that the applied carriers entries as they are defined at time t2, may or may not differ from the earlier entries at time t1 and the same applies to the allocated resources ATR21t2, ATR22t2, ATR23t2 . . . ATR2mt2. It should however be noted that just one change in either, a modified entry or a modification in the description or constraints related to available terminal resources preferably should invoke an updating of the updated terminal resource demand relating to the entries unless special circumstances are defined as a room for accepting e.g. latency with respect to updating of the terminal resource plan. Other triggers for updating allocated resource may e.g. be invoked by a user of the system activating an automated optimization procedure, if such procedure is facilitated by the system

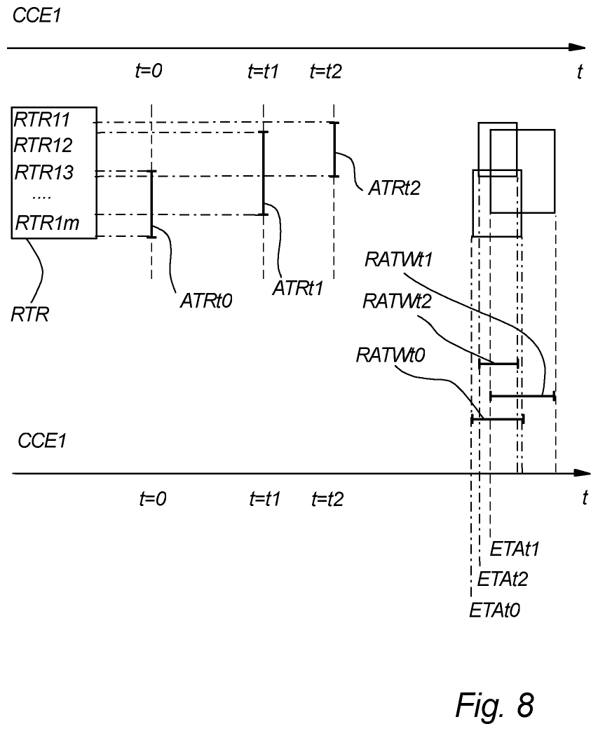

FIG. 8 illustrates a further important feature related an advantageous embodiment of the invention.

A container carrier entry, e.g. the container carrier entry CCE1 referred to in the previous figures, at over time input for processing with reference to the model M or for a modification of an existing model M. The model M and the entry CCE1 is related to a specified terminal.

Representations of available terminal resources RTR are included in the model by respective constraint and optionally relevant mutual constraints. In other words, representations of terminal resources RTR11 . . . RTR1m are a data description of the relevant resources which may be applied for the purpose of executing a container carrier entry. A container carrier entry may in the public space be referred to as a port call.

In essence, the container carrier entry includes at least an associated tentative time of arrival and information regarding a carrier to which the entry is related and also an indication about how many containers the entry relates to for delivery and/or pickup. The tentative time of arrival may to a certain degree be understood conventionally as an estimated time of arrival ETA, but it should be noted that the tentative time of arrival when applied in the context of the invention is intended to cover a continuously modified time, as the inventive technology is in particular aimed and advantageous for the purpose of optimizing and adapting terminal resource plans by moving the tentative arrival time back and forth in time. The same applied to the tentative departure time, which in particular is subject to modification by means of the provisions of the inventive system.

It should be noted that such an entry may be organized and processed in many ways within the scope of the invention. Data may be gathered in records carrying the complete information or preferably be arranged and programmed with pointers to other records.

The container carrier entry CCE1 is input at a time, here illustrated as a time t1. The container carrier entry CCE1 results in a corresponding allocation of a subset of terminal resources. In the present context, terminal resources will from a data perspective be understood as data representations of such resources. Terminal resources may e.g. include quay locations, bollards associated therewith, gangs, etc. Description of such resources and their relevance have been described above.

When allocating resources to the specified container carrier entry CCE1 on the basis of a request, the request will typically include a tentative arrival time. In the present context this tentative arrival time will be regarded as a starting point of when resources of the terminal must be allocated, all calculated at the time t0. Please note that resources may typically be associated with the entry within a resource allocation time window which is starting from the tentative arrival time. It should however be noted that the resource allocation window in principle may include a timing starting from prior the tentative arrival time depending on whether the tentative arrival time is understood as tentative time of berth or whether this time is understood as time of arrival to the terminal sphere. This may be relevant if a terminal includes e.g. a pilot as included in the resource control, as the pilot resource must be allocated a time slot prior to a time slot starting strictly with the time or berthing.

In the present context and for simplification of the present explanation of the concept, the tentative arrival time is simply regarded as an expected time of berthing ETAt0 at the time t0. Time t0 may in this connection be understood as the time at which the initial entry is included in the model M. Typically such initial entry is input weeks or months before the tentative arrival time.

Thus, at time t0, a combination of allocated terminal resources ATRt0 configured from the total set of available terminal resources RTR are included in a preliminary terminal resource plan PTRP. The allocated terminal resources ATRt0 are each associated with time slots within a respective resource allocation time window RATWt0 and the resources are automatically validated by the container carrier terminal system to ensure and provide the tentative arrival time and preferably also a respective tentative departure time related to the entry CCE1.

At time t1, the terminal resource plan is updated into an updated terminal resource plan UTRP. This may be either a result of changes related to terminal resources available for the executing of the respective entry CCE1 in the future, as a result of changes related to the entry CCE1 itself, as a result of changes in other entries already contained or dealt with by the model or it may be inclusion of a new entry related in the model, i.e. as a result of a new port call in the resource plan related to the specified terminal. The update may also be triggered according to time, e.g. at predetermined time intervals, at scheduled update times, coinciding with scheduled low activity times, etc.

The updated resource plan is now, at time t1, including an updated container carrier entry CCE1, where a respective resource allocation time window RATWt1 is including another combinations and ways of using available terminal resources RTR11.TRT1m, e.g. new time slots for specified cranes, other gangs related to the allocated cranes, etc. This updated entry CCE1 is now set to start at a modified future tentative arrival time ETAt1. The illustrates tentative arrival time has in the present illustration been moved further into the future as a result of the automatically validated allocated terminal resources ATRt1.

At time t2, the terminal resource plan is updated again and this has the result that the updated carrier entry CCE1 is to be tentatively operated in a new allocation time window RATWt2.

This updated entry CCE1 is now set to start at a modified future tentative arrival time ETAt2. The illustrated tentative arrival time has been moved back in time as a result of the automatically validated and allocated resources ATRt2. It should be noted that the illustrated entry illustrates a time flow where the entry I automatically validated as from t=t0 and that valid resources have been allocated to the entry. It is however within the scope of the invention either to allow entries into the container carrier terminal system without validation in the sense that terminal resources are not checked for compliance with both existing entries and the new entry. It is however in an embodiment of the invention preferred that the automatic validation from the very time of the inputting of the entry shows whether an entry is associated with violations related to the model forming basis of the system. Such violations may then be dealt with later. In other words, the automatic validation of an entry may include both a positive determination and/or a negative determination of whether it is possible to allocate terminal resources without conflicting with other entries requiring resources already allocated to such entries. Such positive determination may be flagged actively via the user interface, preferably visually. It is however strongly preferred that such negative determination is flagged as soon as possible via the user interface making it clear to the operator that the respective entry at the time being is effectively not operable by the terminal.

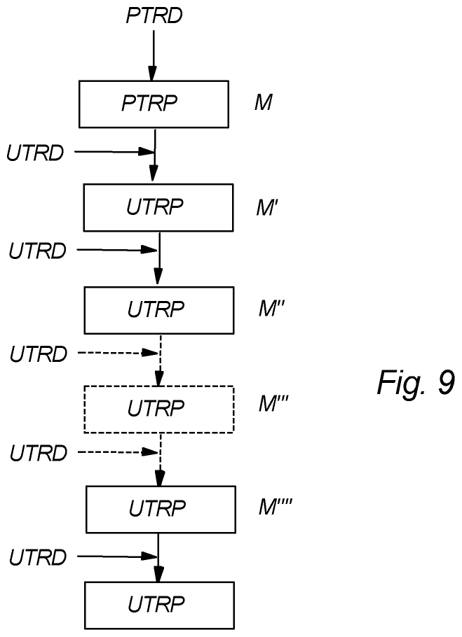

FIG. 9 illustrates how a preliminary terminal resource demand PTRD associated to container carrier entries are resulting in a preliminary terminal resource plan PTRP. It should be noted that the understanding of a preliminary terminal resource plan, e.g. associated with a so-called container carrier entry/port call is that the first established terminal resource plan with respect to this particular container carrier entry is regarded as a preliminary terminal resource plan with respect to this particular new entry, even in spite of the fact that several other entries are already contained and processed in the container carrier terminal system and that the preliminary terminal resource plan to them merely is understood as an updated terminal resource plan UTRP.

This is e.g. the case when an updated terminal resource demand UTRD is happening as illustrated in the flow chart. This updated demand may e.g. be resulting from the inputting of a new entry/request for a new entry, but the specifically illustrated updated terminal resource demand is intended to show that changes in the specific computer carrier entry over time. Such change may e.g. relate to information about the associated carrier, a modified tentative arrival time, a modified tentative departure time, a modified number of containers to be delivered, etc.

The updating will continue, typically a very large number of times. The updating may e.g. be performed 1 time per hour or much more often depending of the activity of the specific terminal and also depending on how often entries are modified. Each time the result is a new updated terminal resource plan.

If the illustrated flow chart represents the “travel” of a specific container carrier entry, the last updated terminal resource plan will be the resource plan according to which the specific entry is handled. Please again note that multiple container carrier entries are also processed and contained at the same time in the updated terminal resource plan as the other container carrier entries “travels” through the model.

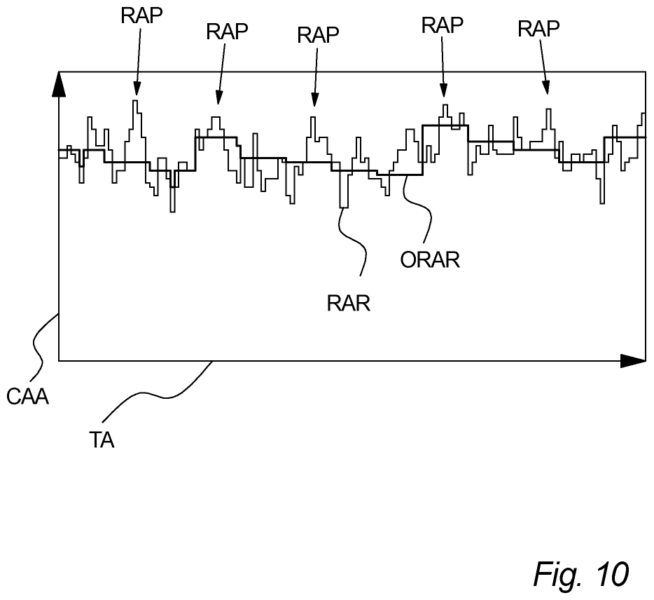

FIG. 10 illustrates a comparison of resource allocation representations. The panel of the figure has a horizontal time axis TA which represents time, where the full extend of the axis corresponds to a week. The panel further has a vertical crane allocation axis CAA which represents a number of allocated cranes.

A resource allocation representation RAR shows the number of allocated cranes in a container carrier terminal which do not operate according to a method of the invention. The shown curve resource allocation representation RAR is based on an exemplary resource allocation of a real container carrier terminal. The curve features many protrusions; it regularly has minima and maxima throughout the extent of the time axis. In other words, the resource allocation representation has a relatively large standard deviation with respect to its average. This represents that the number of allocated cranes throughout the week is relatively irregular. Particularly, several periods of resource allocation peaks RAP are present, in which a large number of cranes are allocated.

The occurrence of resource allocation peaks RAP may be considered a problem of container carrier terminal operations. In such periods, goods are more likely to be delayed, since resources, such as quay cranes, may be lacking. Particularly, a terminal resource demand may exceed the available terminal resources. A constantly changing number of allocated quay cranes may further lead to an increased wear of the quay cranes.

As such, resource allocation peaks RAP are highly undesirable within the field of container carrier terminal operation.

The figure further illustrates another resource allocation representation ORAR—an optimized resource allocation representation. This resource allocation has been achieved using an embodiment of the invention. The embodiment is based on a partial automatic allocation of terminal resources performed using a machine learning-based algorithm configured for reducing resource allocation peaks.

In comparison with the un-optimized resource allocation representation RAR, the optimized resource allocation representation ORAR features no prominent resource allocation peaks RAP.

Note that the areas the curves RAR,ORAR, i.e. the definite integrals of the two curves RAR,ORAR extending the entire duration of the time axis TA, are approximately the same. In the two resource allocation representations RAR,ORAR, the total number of allocated quay crane hours are thus similar, but due to the complexity of resource allocation in container terminals, it is extremely difficult to avoid resource allocation peaks within the prior art.

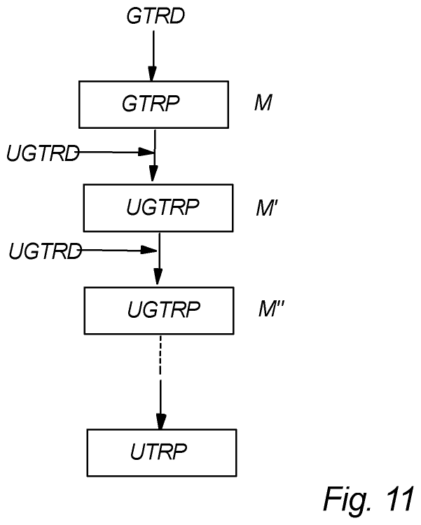

FIG. 11 illustrates a further advantageous feature of embodiments of the invention.

The container carrier terminal system CCTS is in this embodiment configured to handle simultaneous ghost entries GE of one or more container carrier entries CCE already contained and validated in the current active terminal resource plan. The ghost entry may also be understood as an entry which does not presently exist in the terminal resource plan. The first type of ghost entry may be applied and utilized for an intended modification of an existing entry without compromising the database containing entries of the current active terminal resource plan. The current terminal resource plan may also be understood as relying and operating on a master database. The latter type of ghost entry may simply be a way of checking an entry with respect to validity prior to inputting into the master database.

Initially a copy of the at any time current terminal resource plan is made from the master database and the copy is here referred to as a ghost terminal resource plan GTRP. The resource plan may from here be modified within affecting the master database. The ghost terminal resource plan includes ghost information about presently contained container carrier entries and presently respective allocated terminal resources. A modification, either made by means of an automatic optimization routine or manually by a user e.g. by inserting the ghost entry via a suitable user interface may then be applied to the ghost terminal resource plan as an update ghost terminal resource demand and a new updated ghost terminal resource plan is generated. This may happen a number of times, each time assisted by an automated validation of the modified entry/the modified entries and of course an automated validation of other entries of the ghost database affected or potentially affected by the modified ghost entry. When finally a ghost entry has been modified satisfying the needs of the user and complying with the complete updated ghost terminal resource plan of ghost entries and associated constraints of allocated resources, the ghost entries may be transferred to the existing master database and thereby resulting in an updated terminal resource plan. A supplemental validation of the entry or entries may be appropriate in the master plan, the now updated terminal resource plan, if there in the meantime has been made changes in other entries, demands or resources in the master data base.

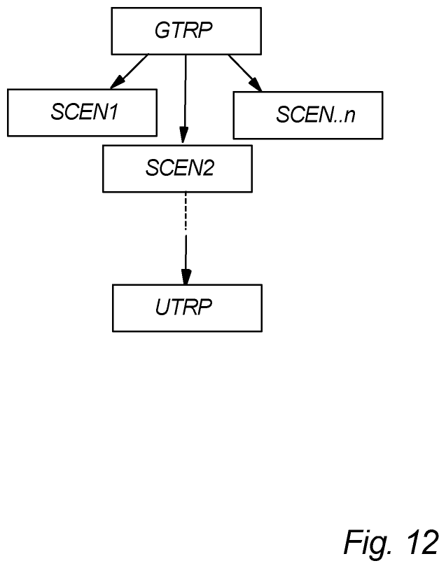

FIG. 12 illustrates a further advantageous technical feature of the invention, namely the features related to the application of multiple scenarios.

In a ghost database derived from the master database, the principle explained above, a user may modify selected entries, here ghost entries. These entries may e.g. be modified in order to fit other entries into an already updated and current terminal resource plan.

The system thus provides for the application of different scenarios, here SCEN1, SCEN2 and SCENn. In these different scenarios a user of the system may check different ways of modifying one or more container carrier entries in order to optimize or fit them into the plan. This task may sometimes be a difficult on, and the application of different scenarios makes it possible for a user to check different ways of modifying entries without compromising the master data base.

One, two or more (here n) scenarios may be tested, and when a useful configuration of allocated terminal resources has been found in combination with modified container carrier entries, these entries may be transferred into the master database and an updated terminal resource plan UTRP has been created.

It should be noted that the multiple scenario design within the scope of the invention is in particular useful as the system is designed for automatic validation of the entries affected of each scenario. A user may thus be able to intuitively check different ways of configuring the entries, typically related to a need of a modifying an entry with respect to e.g. a tentative time of arrival, number of containers to be dealt with, etc.

In the present context all validation may be performed automatically unless specifically otherwise noted.

At least two principally different ways of initiating a validation may be applied within the scope of the invention. A fully automatic initiation which simply validates when instructed by the planning program logic. Such autonomous validation may not necessary be overruled by a semi-automatic validation which is automatically initiated when a user of a user interface provides inputs e.g. modification(s) of container carrier entries, additions or removals of container carrier entries, modifications of existing available terminal resources, additions or removals terminal resources, modifications of constraints such as maintenance etc.

A validation in the present context can for example involve an analysis of whether one, all, or a group of container carrier entries are “matched” with allocated terminal resources. In other words, are the demands related to the container carrier entries fulfilled by the terminal resources allocated to the container carrier entries already input and made active in the a preliminary PTRP or updated terminal resource plan UTRP. It may also refer to a non-validated terminal resource plan of ghost entries which is in its making e.g. on the basis of a modification of an active updated terminal resource plan UTRP. Such validation may thus be made on ghost data of one scenario based on a modification of an existing terminal resource plan, preliminary or updated terminal resource plan, but it may also be performed on several alternative scenarios of which a berth planner may choose to make one of these active as an updated terminal resource plan.

A validation may be performed if something has changed in the existing active distribution of container carrier entries vs respective allocated terminal resources and upon registration by manual input of this change by a user of the user interface or by an automatic registration of the change, an automatic validation is performed across all configured container carrier entries vs respective allocated terminal resources. Such a validation may in the present context not only just validate whether the allocation is OK, but it can optionally also result in a warning displayed or otherwise communicated to a user of the container carrier terminal system planning system (which may also be referred to and understood as a berth plan configurator), if the it turns out the present demands as expressed by the container carrier entries (and optional associated logic) are not met validly by the presently allocated terminal resources.

Factors relevant for such demands may e.g. refer to time, ETA and ETD, number of containers to be unloaded, which resources are available for the unloading, berth locations, cranes, crane gangs etc.

A validation may also be performed for the purpose of checking whether a auxiliary resource scenario is valid before implementing that scenario as the master resource scenario in an updated terminal resource plan UTRP. In other words, such a situation may occur upon a determination the existing berth plan/resource plan is not valid anymore (e.g. due to updated constraints or demands) and now the berth planner and/or an automatic routine are trying to figure out which adjustments to implement to ensure that allocated resources comply with demands once again. This may not always be an easy task and in an advantageous embodiment of the invention, changes of an existing and active berth plan are not made before the considered changes are validated by the system, e.g. as one or more alternatives which may be checked/validated before being made active as an updated terminal resource plan.

In other words, the container carrier terminal system enables that a user may validate a plan before making it active as well as validate the resource plan automatically if changes has occurred in relation to container carrier entries, allocated terminal resource, demands, or constraints such as maintenance.

It should be noted that the above changes may of course relate to if a container carrier entry is added or deleted, and if terminal resources are added or deleted, but the changes may preferably also include changes in demands, such as ETA and ETD, number of containers to be unloaded, and also whether the allocated resources has a modified performance, e.g. a part of the berth is not available, a crane is now non-available in relation to maintenance, a crane is now more or less efficient due to maintenance or availability of a more or less efficient gang, a crane is not applicable for certain berth positions due to another crane down for maintenance which is blocking the track, etc.

In other words, changes which preferably trigger automatic validation includes modified demand and modified resources.

A validation in the present context should preferably also result in a communication, e.g. by displaying, one or more factual conflicts/violations if such are available and the validation should preferably also result in the that such conflicts are categorized such that a manual operator of the configurator, i.e. the container carrier terminal system, is able to perceive the detected conflicts and make a modification of the berth plan on the basis of these. Such categorization of conflicts may include determination that specific cranes are now “double booked” or that specific cranes are already booked (if trying to validate a new container carrier entry) and the quantization could also include when the specific crane(s) are available or not.

This categorization may advantageously also be present and provided to a user upon a positive validation, i.e. if it turns out that the berth planner has succeeded in finding a new way of implementing allocations which comply with the demands. This may in particular be of user for a berth planner when the berth planner seeks to find more and alternative configurations to meet the same demand. This may e.g. be performed by working out separate resource scenarios and automatically having these validated. It may of course be very difficult to find a valid new configuration, e.g. if a demand it updated (e.g. a new ETA) or if a crane is requiring planned or acute maintenance, but it is even more difficult to find and optimize a new configuration where the allocated resources match the demand.

In an advantageous embodiment of the invention, the configurator, i.e. the container carrier terminal system, allows the planner to work with multiple alternative scenarios prior to making one of these active but the validation not only provides quantized (detailed) warning if a scenario is not valid, but also provides details if the scenario is valid. Such details could e.g. be an overall automatic calculation of the added cost in relation to gangs/workforce of a certain configuration is used. Several other parameters may also be outputted for the assisting of the berth planner to determine which valid scenario to choose and activate.

In a further embodiment of the invention, such classifications may be both shown (made available, e.g. be automatically displayed) to the berth planner. The respective quantization of the different scenarios may also be logged for the training of artificial intelligence to determine typical priorities made when a berth planner chooses one scenario over another. This may be used for an automatic computer-made choosing of one scenario over another/others scenario(s) or at least an automatic prioritizing of these scenarios which may be communicated to the berth planner for the assisting of the berth planner in choosing the optimal valid scenario among a number of valid scenarios.

In a computer implemented validation according to an embodiment of the invention, an auxiliary resource scenario is to be validated before being considered for activation and use as a master resource scenario/updated terminal resource plan. The auxiliary resource scenario may e.g. be established to figure out how to handle a planned maintenance or a breakdown (urgent) maintenance in an optimal way.

The auxiliary scenario is initially validated by a validation process by data processing equipment DPE (as shown in FIG. 3) in a validation process step.

If outcome of the validation is that the auxiliary scenario is OK, the auxiliary scenario is then classified in a classification step. The classification involves that a number of different aspects, e.g. cost related to the specific maintenance used in the validated auxiliary scenario. Further costs may also be included in relation to the classification of the validated scenario, which may e.g. include classification of induced and required delays of container carrier entries involved in the establishment a new and valid berth plan, cost related to use of gangs in the scenario, priority given to certain container carrier operators etc.

Such classifications may then be stored and logged in a database and also displayed to a user in graphical user interface.

If, on the other hand the auxiliary scenario is turning out to be non-OK in the validation step, the in-validity of the scenario is categorized so as to allow the berth planner to find out where the conflicts are and preferably also the extent of determined the conflict(s).

The result is then displayed in a display step and the result may also be stored and logged in a database.

The above validation may be repeated for each auxiliary scenario and for each time an auxiliary scenario is updated with respect to demands and/or terminal resources.

### LIST OF REFERENCE SIGNS

CAA Crane allocation axis
CADR Crane allocation data record
CC Container carrier
CCDR Container carrier data record
CCE Container carrier entry
CCEDR Container carrier entry data record
CCT Container carrier terminal
CCTDR Container carrier terminal data record
CCTS Container carrier terminal system
DPE Data processing equipment
GADR Gang allocation data record
GDR Gang data record
GUI Graphical user interface
MDR Maintenance data record
NOV Notice of violation
ORAR Optimized resource allocation representation
Q Quay
QC Quay crane
QCA Quay crane allocation
QCR Quay crane data record
QL Quay length
RAE Resource allocation environment
RAP Resource allocation peak
RAR Resource allocation representation
SC Shipping container
SR Sailing route
TA Time axis
TAT Tentative arrival time
TDT Tentative departure time

1-110. (canceled)

111. A method of operating a container carrier terminal, comprising the steps of:
providing a computer implemented container carrier terminal system comprising a model of said container carrier terminal executed on data processing equipment, said model comprising representations of terminal resources and terminal constraints relating to said terminal resources, wherein said terminal resources comprise a plurality of quay cranes and said representations of terminal resources including representations of said plurality of quay cranes;
inputting, in said container carrier terminal system a plurality of container carrier entries, each container carrier entry relating to a container carrier and associated with a preliminary terminal resource demand including a tentative arrival time, wherein said tentative arrival time is indicative of arrival of said container carrier to said container carrier terminal;
allocating a respective subset of said terminal resources to each container carrier entry of said plurality of container carrier entries to obtain a preliminary terminal resource plan of allocated terminal resources, wherein said step of allocating terminal resources comprises automatically validating said allocated terminal resources of the container carrier entries,
the allocated terminal resources including a subset of said plurality of quay cranes, wherein the validating includes automatically establishing whether the allocated terminal resources of the container carrier entries comply with said terminal constraints and said preliminary terminal resource demand associated with said plurality of container carrier entries;
providing an updated terminal resource demand relating to at least one of said plurality of container carrier entries; and
processing an updated terminal resource plan on the basis of said updated terminal resource demand by means of said computer implemented container carrier terminal system.

112. The method according to claim 111, wherein said updated terminal resource demand is provided based on output from one or more container carriers and/or on output from a control center associated with at least one of said one or more container carriers.

113. The method according to claim 111, wherein said updated terminal resource demand comprises an updated tentative arrival time and/or an updated tentative departure time.

114. The method according to claim 111, wherein said updated terminal resource demand comprises an updated cargo capacity to be loaded, unloaded, and/or redistributed at said container carrier terminal.

115. The method according to claim 111, wherein said step of processing an updated terminal resource plan comprises allocating a respective subset of said terminal resources, including said plurality of quay cranes, to each container carrier entry of said plurality of container carrier entries, and wherein said step comprises automatically distributing terminal resources, including said plurality of quay cranes, to said plurality of container carrier entries to comply with said updated terminal resource demand and said terminal constraints.

116. The method according to claim 111, wherein said container carrier terminal system is associated with a database comprising a plurality of container carrier data records, and wherein each of said plurality of container carrier data records comprises data associated with a respective container carrier of said plurality of container carriers.

117. The method according to claim 111, wherein said container carrier entries are inputted in a resource allocation environment of said container carrier terminal system, and wherein said resource allocation environment is represented by a graphical user interface of said container carrier terminal system.

118. The method according to claim 111, wherein said representations of terminal resources of said model are representations of terminal resources which are physically present at said container carrier terminal, such as physical quay cranes, physical quay lengths, one or more physical bollards, and one or more physical gangs.

119. The method according to claim 111, wherein said preliminary terminal resource demand comprises a container carrier length and/or a tentative departure time.

120. The method according to claim 111, wherein said preliminary terminal resource demand comprises cargo capacity to be loaded, unloaded, and/or redistributed at said container carrier terminal.

121. The method according to claim 111, wherein said terminal constraints comprises any of quay depth, quay move restrictions, quay crane maintenance and weather restrictions.

122. The method according to claim 111, wherein said step of allocating a respective subset of said terminal resources to each container carrier entry of said plurality of container carrier entries comprises allocating a respective quay position to each container carrier entry of said plurality of container carrier entries.

123. The method according to claim 111, wherein said automatically validating and/or at least partly distributing terminal resources is carried out with respect to one or more allocation targets, and wherein said one or more allocation targets comprise an allocation target from the list of earlier time of departure ETD, later arrival ETA, reduced between-tasks crane movement, reduced number of resource allocation peaks, and reduced magnitude of resource allocation peaks.

124. The method according to claim 111, wherein said automatically validating and/or distributing terminal resources is performed on the basis of an optimization routine, and wherein said optimization routine is arranged to distribute terminal resources to comply with said terminal constraints and said preliminary terminal resource demand and/or said updated terminal resource demand and to optimize distribution of terminal resources with respect to one or more optimization targets.

125. The method according to claim 111, wherein said method comprises a step of operating said container carrier terminal by operating said terminal resources on the basis of said updated terminal resource plan, and wherein said step of operating said container carrier terminal comprises operating one or more of said plurality of quay cranes on the basis of said updated terminal resource plan.

126. The method according to claim 111, wherein said step of allocating a respective subset of said terminal resources comprises identifying whether said allocated terminal resources comply with said preliminary terminal resource demand associated with said plurality of container carrier entries and providing at least one notice of violation when said allocated terminal resources does not comply with said preliminary terminal resource demand, wherein each notice of violation of said at least one notice of violation is provided together with one or more violation solution suggestions, wherein implementation of a violation solution suggestion of said one or more violation solution suggestions in said preliminary terminal resource plan result in said allocated terminal resources complying with said subset of said preliminary terminal resource demand, and wherein a violation solution suggestion of said one or more violation solution suggestions comprises changing any of said tentative arrival time, said tentative departure time, said terminal constraints, said preliminary terminal resource demand, and a quay crane efficiency.

127. The method according to claim 111, wherein said container carrier terminal system comprises a plurality of resource scenarios comprising a master resource scenario and at least one auxiliary resource scenario, wherein each resource scenario of said plurality of resource scenarios is a graphical representation of at least one resource plan of any of said preliminary terminal resource plan and said updated terminal resource plan, wherein said step of allocating a respective subset of said terminal resources is performed in one of said at least one auxiliary resource scenario, and wherein said master resource scenario is arranged to be updated on the basis of one of said at least one auxiliary resource scenarios.

128. The method according to claim 111, wherein said step of validating comprises establishing whether said allocated terminal resources comply with said tentative arrival times of said preliminary terminal resource demands.

129. The method according to claim 111, wherein said step of allocating said respective subset of said terminal resources is restricted to a subset of said plurality of container carrier entries.

130. A container carrier terminal system comprising data processing equipment configured to execute a model of a container carrier terminal, said model comprising representations of terminal resources and terminal constraints relating to said terminal resources; said terminal resources comprising a plurality of quay cranes and said representations of terminal resources including representations of said plurality of quay cranes;
the container carrier terminal system comprising an input configured to receive a plurality of container carrier entries, each container carrier entry relating to a container carrier and associated with a preliminary resource demand including a tentative arrival time, wherein said tentative arrival time is indicative of arrival of said container carrier to said container carrier terminal;
the container carrier terminal system being configured to allocate a respective subset of said terminal resources to each container carrier entry of said plurality of container carrier entries to obtain a preliminary terminal resource plan of allocated terminal resources, wherein said allocation comprises automatically validating and/or distributing terminal resources, including said plurality of quay cranes, to said plurality of container carrier entries to comply with said terminal constraints and said preliminary terminal resource demand associated with said plurality of container carrier entries; and
the container carrier terminal system being configured to process an updated terminal resource plan on the basis of an updated terminal resource demand relating to said plurality of container carrier entries.
